(19) United States
(12) Patent Application Publication
(10) Pub. No.: US 2014/0200140 A1
(43) Pub. Date: Jul. 17, 2014

(54) METHOD OF CONTROLLING PESTS

(71) Applicant: SUMITOMO CHEMICAL COMPANY, LIMITED, Tokyo (JP)

(72) Inventor: Hajime IKEDA, Kasai-shi (JP)

(73) Assignee: SUMITOMO CHEMICAL COMPANY, LIMITED, Tokyo (JP)

(21) Appl. No.: 14/144,083

(22) Filed: Dec. 30, 2013

(51) Int. Cl. A01N 43/84

(52) U.S. Cl. CPC A01N 43/84
USPC 504/128; 504/225; 504/130

(57) ABSTRACT

The present invention relates to a method of controlling weeds in a crop field, the method including treating the crop field with crystal of flumioxazin described in the specification, before sowing or planting, at the same time of sowing or planting, or after sowing or planting crop seeds or vegetative organs such as tubers, bulbs, or stem fragments which are treated with one or more compounds selected from the following group B;
Group B: neonicotinoid type compounds, diamide type compounds, carbamate type compounds, organic phosphorous type compounds, biological nematicidal compounds, other insecticidal compounds and nematicidal compounds, azole type compounds, strobilurin type compounds, metalaxyl type compounds, SDHI compounds, and other fungicidal compounds and plant growth regulators.

According to the method of controlling pests of the present invention, weeds in clop fields can be efficiently controlled.

### BACKGROUND OF THE INVENTION

1. Field of the Invention

The present invention relates to a pest control method, that is, a method of controlling pests such as harmful arthropod pests, nematodes, plant pathogens, and/or weeds.

2. Description of the Related Art

Various compounds are known as effective components for insecticides, nematicides, or fungicides. Also, flumioxazin is known as an effective component for herbicides.

### PRIOR ART LITERATURE

### Patent Literature

Patent Literature 1: U.S. Pat. No. 3,799,758 Non-Patent Literatures
Non-Patent Literature 1: Crop Protection Handbook, vol. 98 (2012) Meister Publishing Company, ISBN: 1-892829-25-8)
Non-Patent Literature 2: Compendium of Pesticide Common Names (http//www alanwood.net/pesticides/)

### SUMMARY OF THE INVENTION

It is an object of the present invention to provide a method for producing an excellent effect on pest control in crop fields.

The present invention relates to a method of controlling pests grown in a crop field by treating the crop field with flumioxazin constituted of a specific crystal structure before sowing or planting, at the same time of sowing or planting, or after sowing or planting crop seeds or vegetative organs such as tubers, bulbs, or stem fragments which are treated with one or more specific insecticidal compounds, nematicidal compounds, or fungicidal compounds.

The present invention is as follows.

[1] A method of controlling weeds in a crop field, the method including treating the crop field with crystal of flumioxazin, before sowing or planting, at the same time of sowing or planting, or after sowing or planting crop seeds or vegetative organs such as tubers, bulbs, or stem fragments which are treated with one or more compounds selected from the following group B;

Group B: neonicotinoid type compounds, diamide type compounds, carbamate type compounds, organic phosphorous type compounds, biological nematicidal compounds, other insecticidal compounds and nematicidal compounds, azole type compounds, strobilurin type compounds, metalaxyl type compounds, SDHI compounds, and other fungicidal compounds and plant growth regulators,

wherein the crystal of flumioxazin is one or more selected from the group consisting of 1^{st} crystal, 2^{nd} crystal, 3^{rd} crystal, 4^{th} crystal, 5^{th} crystal, 6^{th} crystal and 7^{th} crystal,

each of the crystals showing a powder X-Ray diffraction pattern which has diffraction peaks with 2θ values (°) shown in the corresponding right column of Table 1,

TABLE 1

| | 2θ value (°) |
|---|---|
| 1^{st} crystal | 7.5 ± 0.1, 11.9 ± 0.1, 15.3 ± 0.1 |
| 2^{nd} crystal | 8.7 ± 0.1, 9.4 ± 0.1, 14.7 ± 0.1, |
| | 18.8 ± 0.1 |
| 3^{rd} crystal | 7.7 ± 0.1, 10.9 ± 0.1, 13.5 ± 0.1, |
| | 14.6 ± 0.1, 15.0 ± 0.1 |
| 4^{th} crystal | 7.7 ± 0.1, 10.7 ± 0.1, 13.4 ± 0.1, |
| | 14.3 ± 0.1, 14.8 ± 0.1 |
| 5^{th} crystal | 5.5 ± 0.1, 10.3 ± 0.1, 10.9 ± 0.1, |
| | 13.2 ± 0.1 |
| 6^{th} crystal | 7.7 ± 0.1, 8.6 ± 0.1, 11.0 ± 0.1, |
| | 13.2 ± 0.1, 14.7 ± 0.1, 15.1 ± 0.1, |
| 7^{th} crystal | 14.5 ± 0.1, 18.7 ± 0.1 |
| . | |

[2] A method of controlling pests in a crop field, the method including the steps of:

treating crop seeds or vegetative organs such as tubers, bulbs, or stem fragments with one or more compounds selected from the group B: neonicotinoid type compounds, diamide type compounds, carbamate type compounds, organic phosphorous type compounds, biological nematicidal compounds, other insecticidal compounds and nematicidal compounds, azcle type compounds, strobilurin type compounds, metalaxyl type compounds, SDHI compounds, and other fungicidal compounds and plant growth regulators; and

treating the crop field with crystal of fluraicxazin, before sowing or planting, at the same time of sowing or planting, or after sowing or planting the crop seeds or vegetative organs such as tubers, bulbs, or stem fragments which are treated with the compounds of the group B,

wherein the crystal of flumioxazin is one or more selected from the group consisting of 1^{st} crystal, 2^{nd} crystal, 3^{rd} crystal, 4^{th} crystal, 5^{th} crystal, 6^{th} crystal and 7^{th} crystal,

each of the crystals showing a powder X-Ray diffraction pattern which has diffraction peaks with 2θ values (°) shown in the corresponding right column of Table 1,

TABLE 1

| | 2θ value (°) |
|---|---|
| 1^{st} crystal | 7.5 ± 0.1, 11.9 ± 0.1, 15.3 ± 0.1 |
| 2^{nd} crystal | 8.7 ± 0.1, 9.4 ± 0.1, 14.7 ± 0.1, |
| | 18.8 ± 0.1 |
| 3^{rd} crystal | 7.7 ± 0.1, 10.9 ± 0.1, 13.5 ± 0.1, |
| | 14.6 ± 0.1, 15.0 ± 0.1 |
| 4^{th} crystal | 7.7 ± 0.1, 10.7 ± 0.1, 13.4 ± 0.1, |
| | 14.3 ± 0.1, 14.8 ± 0.1 |
| 5^{th} crystal | 5.5 ± 10.1, 10.3 ± 0.1, 10.9 ± 0.1, |
| | 13.2 ± 0.1 |
| 6^{th} crystal | 7.7 ± 0.1, 8.6 ± 0.1, 11.0 ± 0.1, |
| | 13.2 ± 0.1, 14.7 ± 0.1, 15.1 ± 0.1, |
| 7^{th} crystal | 14.5 ± 0.1, 18.7 ± 0.1 |

[3] The control method according to [1] or [2], wherein the group B is the following compounds:

group B:

B-1. neonicotinoid type compounds: clothianidin, thiamethoxam, imidacloprid, dinotefuran, nitenpyram, acetamiprid, and thiacloprid;

diamide type compounds: flubendiamide, chlorantraniliprole, cyantraniliprole, and compounds represented by the formula (I):

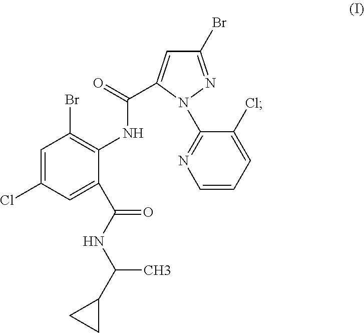 [SMILES: CC(NC(=O)c1cc(Cl)cc(Br)c1NC(=O)c1cc(Br)nn1-c1ncccc1Cl)C1CC1]

B-2. carbamate type compounds: aldicarb, oxamyl, thiodicarb, carbofuran, carbosulfan, and dimethoate;

B-3. organic phosphorous type compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;

B-4. biological nematicidal compounds: Harpin Protein, Pasteuria nishizawae, Pasteuria penetrans, Myrothecium verrucaria, Burholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;

B-5. other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;

B-6. azole type compounds: azaconazole, bitertanol, bromuconazole, cyproconazole, diphenoconazole, diniconazole, epoxyconazole, fenbuconazole, fluquinconazole, flusilazole, flutriafol, hexaconazole, imibenconazole, ipconazole, metconazole, mycrobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizol;

B-7. strobilurin type compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxy)methyl]phenyl-2-methoxy-acetamide (racemic or enantiomer, containing a mixture of R-enantiomer and S-enantiomer (optional ratio));

B-8. metalaxyl type compounds: metalaxyl and metalaxyl-M;

B-9. SDHI compounds: sedaxane, penflufen, carboxin, boscalid, furametpyr, flutolanil, fluxapyroxad, isopyrazam, fluopyram, and thifluzamide;

B-10. other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and

B-11. plant growth inhibitors: ethephon, chlormequat-chloride, mepiquat-chloride, and 4-oxo-4-(2-phenylethyl)aminobutyric acid.

[4] The control method according to any one of [1] to [3], wherein the crop is soybean, peanut, common bean, pea, corn, cotton, wheat, rice, sunflower, potato, sugar cane, or vegetables.

[5] The control method according to any one of [2] to [4], wherein the pests are weeds and/or arthropods and/or plant pathogens.

[6] The control method according to any one of [2] to [4], wherein the pests are weeds.

Pests in crop fields can be controlled by the method of controlling pests according to the present invention.

### DETAILED DESCRIPTION OF THE PREFERRED EMBODIMENTS

A method of controlling pests according to the present invention (hereinafter referred to as a method of the present invention) includes the steps of:

(1) treating crop seeds or vegetative organs such as tubers, bulbs, or stem fragments with one or more compounds selected from the group B consisting of specific insecticidal compounds, nematicidal compounds, and fungicidal compounds; and

(2) treating a crop field with crystal of flumioxazin, before sowing or planting, at the same time of sowing or planting, or after sowing or planting the crop seeds or vegetative organs such as tubers, bulbs, or stem fragments which are treated with the compounds of the group B, wherein the crystal of flumioxazin is one or more selected from the group consisting of 1^{st} crystal, 2^{nd} crystal, 3^{rd} crystal, 4^{th} crystal, 5^{th} crystal, 6^{th} crystal and 7^{th} crystal,

each of the crystals showing a powder X-Ray diffraction pattern which has diffraction peaks with 28 values (°) shown in the corresponding right column of Table 1,

TABLE 1

| | 2θ value (°) |
|---|---|
| 1^{st} crystal | 7.5 ± 0.1, 11.9 ± 0.1, 15.3 ± 0.1 |
| 2^{nd} crystal | 8.7 ± 0.1, 9.4 ± 0.1, 14.7 ± 0.1, |
| | 18.8 ± 0.1 |
| 3^{rd} crystal | 7.7 ± 0.1, 10.9 ± 0.1, 13.5 ± 0.1, |
| | 14.6 ± 0.1, 15.0 ± 0.1 |
| 4^{th} crystal | 7.7 ± 0.1, 10.7 ± 0.1, 13.4 ± 0.1, |
| | 14.3 ± 0.1, 14.8 ± 0.1 |
| 5^{th} crystal | 5.5 ± 10.1, 10.3 ± 0.1, 10.9 ± 0.1, |
| | 13.2 ± 0.1 |
| 6^{th} crystal | 7.7 ± 0.1, 8.6 ± 0.1, 11.0 ± 0.1, |
| | 13.2 ± 0.1, 14.7 ± 0.1, 15.1 ± 0.1, |
| 7^{th} crystal | 14.5 ± 0.1, 18.7 ± 0.1 |

Hereinafter, the crystal of flumioxazin is referred to as “1^{st} crystal of flumioxazin, 2^{nd} crystal of flumioxazin, 3^{rd} crystal of flumioxazin, 4^{th} crystal of flumioxazin, 5^{th} crystal of flumioxazin, 6^{th} crystal of flumioxazin and 7^{th} crystal of flumioxazin, respectively”.

Examples of the crops to which the method of the present invention is applied include food crops such as soybean, corn, cotton, wheat, barley, rye, triticale, rice, peanut, common bean, lima bean, azuki bean, cowpeas, mung bean, black lentil, scarlet runner bean, vigna umbellate, moth bean, tepary bean, broad bean, pea, garbanzo bean, lentil, lupine, pigeon pea, and potato; forage crops such as sorghum, oat, and alfalfa; industrial crops such as sugar beet, sunflower, rapeseed, and sugar cane; and garden crops such as Solanaceae vegetables (for example, eggplant, tomato, green pepper, bell pepper, and hot pepper), Cucurbitaceae vegetables (for example, cucumber, pumpkin, zucchini, watermelon, and melon), Cruciferous vegetables (for example, Japanese radish, turnip, horseradish, kohlrabi, Chinese cabbage, cabbage, brown mustard, broccoli, and cauliflower), Compositae vegetables (for example, burdock, garland chrysanthemum, artichoke, and lettuce), Liliaceae vegetables (for example, Welsh onion, onion, garlic, asparagus), Umbelliferae vegetables (carrot, parsley, celery, and parsnip), Chenopodiaceae vegetables (for example, spinach and Swiss chard), Labiatae vegetables (for example, Japanese mint, mint, basil, and lavender), strawberry, sweet potato, yam, and aroid.

The method of the present invention is applied particularly to soybean, peanut, common bean, pea, corn, cotton, wheat, rice, sunflower, potato, sugar cane, or vegetables.

When the method of the present invention is applied to sugar cane, stem fragments cut so as to have one stalk may be used as the stem fragment of sugar cane, or stem fragments having a size of 2 cm to 15 cm may be used in the cultivation of sugar cane. Sugar cane cultivation methods using such stem fragments are publicly known (WO 09/000,0398, WO 09/000,399, WO 09/000,400, WO 09/000,401, and WO 09/000,402) and performed under the brand name of Plene (trademark).

The above crops include plants to which resistance to Protoporphyrinogen IX oxidase inhibitors such as flumioxazin; 4-hydroxyphenylpyrubic acid dioxygenase inhibitors such as isoxaflutole; acetolactic acid synthase inhibitors such as imazethapyr and thifensulfuron-methyl; 5-enolpyruvylshikimate-3-phosphoric acid synthase inhibitors such as glyphosate; glutamine synthetase inhibitors such as glufosinate; auxin type herbicides such as 2,4-D and dicamba; and herbicides such as bromoxinyl are imparted by classical breeding methods or genetic modification technologies.

As examples of crops to which resistance has been imparted by classical breeding methods, corn resistant to imidazolinone type acetolactic acid synthase inhibitory herbicides such as imazethapyr is given and has already been commercially available under the trade name of Clearfield (trademark). Examples of such crops include STS soybeans resistant to sulfonylurea type acetolactic acid synthase inhibitory herbicides such as thifensulfuron-methyl. Similarly, examples of a plant to which resistance to an acetyl CoA carboxylase inhibitor such as triune oxime-based or aryloxyphenoxypropionic acid-based herbicide has been imparted by classical breeding methods include SR corn.

Examples of a plant to which resistance has been imparted by genetic modification technologies include corn, soybeans and cotton resistant to glyphosate, and they have already been commercially available under the trade names of RoundupReady (registered trade mark), Agrisure (registered trademark) GT, Gly-Tol (registered trademark) and the like. Similarly, there are corn, soybeans and cotton resistant to glufosinate by genetic modification technologies, and they have already been commercially available under the trade names of LibertyLink (registered trademark) and the like. There are varieties of corn and soybeans under the trade names of Optimum (registered trademark) GAT (registered trademark), which are resistant to both of glyphosate and acetolactic acid synthase inhibitor. Similarly, there are soybeans resistant to imidazolinone type acetolactic acid synthase inhibitors by genetic modification technologies, and they have been developed under the name of Cultivance. Similarly, there is cotton resistant to bromoxynil by genetic modification technologies, and this has already been commercially available under the trade name of BXN (registered trademark). Similarly, there is a variety of soybean sold under the trade name of RoundupReady (registered trademark) 2 Xtend as a soybean resistant to both of glyphosate and dicamba by genetic modification technologies. Similarly, there has been developed cotton resistant to both of glyphosate and dicamba by genetic modification technologies.

A gene encoding aryloxyalkanoate dioxygenase may be introduced to produce a crop which becomes resistant to phenoxy acid type herbicides such as 2,4-D, MCPA, dichlorpropand mecoprop, and aryloxyphenoxypropionic acid type herbicides such as quizalofop, haloxyfop, fluazifop, diclofop, fenoxaprop, metamifop, cyhalofop and clodinafop (Wright et al. 2010: Proceedings of National Academy of Science. 107 (47): 20240-20245). Cultivars of soybean and cotton, which show the resistance to 2,4-D, have been developed under the brand of Enlist.

A gene encoding a 4-hydroxyphenyl pyruvic acid dioxygenase (hereinafter referred to as HPPD) inhibitor, the gene having resistance to HPPD, may be introduced to create a plant resistant to a HPPD inhibitor (US2004/0058427). A gene capable of synthesizing homogentisic acid which is a product of HPPD in a separate metabolic pathway even if HPPD is inhibited by a HPPD inhibitor is introduced, with the result that a plant having resistance to the HPPD inhibitor can be created (WO02/036787). A gene expressing excess HPPD may be introduced to produce HPPD in such an amount as not to adversely affect the growth of plants even in the presence of a HPPD inhibitor, with the result that a plant having resistance to the HPPD inhibitor can be created (WO96/38567). Besides introduction of the gene expressing excess HPPD, a gene encoding prephenate dehydrogenase is introduced in order to increase the yield of p-hydroxyphenyl pyruvic acid which is a substrate of HPPD to create a plant having resistance to the HPFD inhibitor (Rippert P et. al., 2004 Engineering plant shikimate pathway for production of tocotrienol and improving herbicide resistance. Plant Physiol. 134: 92-100).

Examples of a method of producing crops resistant to herbicides include, other than the above, the gene introducing methods described in WO98/20144, WO2002/46387, and 1382005/0246800.

The above crops include, for example, crops which can synthesize selective toxins and the like known as the genus Bacillus by using genetic modification technologies.

Examples of the toxins developed in such genetically modified plants include insecticidal proteins derived from Bacillus cereus and Bacillus popilliae; δ-endotoxins such as Cry1Ab, Cry1Ac, Cry1F, Cry1Fa2, Cry2Ab, Cry3A, Cry3Bb1, Cry9C, Cry34, and Cry35ab derived from Bacillus thuringiensis; insecticidal proteins such as VIP1, VIP2, VIP3, and VIP3A; insecticidal proteins derived from nematodes; toxins produced by animals such as scorpion toxins, spider toxins, bee toxins, and neurotoxins specific to insects; filamentous fungus toxins; plant lectins; agglutinin; trypsin inhibitors, serine protease inhibitors, and protease inhibitors such as patatin, cystatin, and papain inhibitors; ribosome inactivating proteins (RIP) such as lysine, corn-RIP, abrin, lufin, saporin, and bryodin; steroid metabolic enzymes such as 3-hydroxysteroid oxidase, ecdysteroid-UDP-glucosyltransferase, and cholesterol oxidase; ecdysone inhibitors; HMG-CoA reductase; ion channel inhibitors such as sodium channel and calcium channel inhibitors; juvenile hormone esterase; diuretic hormone receptors; stilbene synthase; bibenzyl synthase; chitinase; and glucanase.

The toxins expressed in these transgenic plants include hybrid toxins, partially deficient toxins and modified toxins, which derive from δ-endotoxin proteins such as Cry1Ab, Cry1Ac, Cry1F, Cry1Fa2, Cry2Ab, Cry3A, Cry3Bb1, Cry9C, Cry34Ab and Cry35Ab, and insecticidal proteins such as VIP1, VIP2, VIP3 and VIP3A. The hybrid toxins are created by new combinations of domains having different proteins by using genetic modification technologies. As the partially defective toxins, Cry1Ab in which part of the amino acid sequences is missing is known. In the modified toxin, one or more of amino acids of a natural type toxin is replaced. Examples of these toxins and genetically modified plants capable of synthesizing these toxins are described in, for example, EP-A-0374753, WO 93/07278, WO 95/34656, EP-A-0427529, EP-A-451878, and WO 03/052073. Resistance to noxious insects belonging to order Coleoptera, order Diptera, and order Lepidoptera is imparted to plants by toxins contained in these genetically modified plants.

Also, genetically modified plants which contain one or more insecticidal genes resistant to harmful insects and develop one or more toxins have been already known and some of these plants have been put on the market. Examples of these genetically modified plants include YieldGard (registered trademark) (corn variety expressing Cry1Ab toxin), YieldGard Rootworm (registered trademark) (corn variety expressing Cry3Bb1 toxin), YieldGard Plus (registered trademark) (corn variety expressing Cry1Ab and Cry3Bb1 toxins), Herculex I (registered trademark) (corn variety expressing phosphinothricin N-acetyltransferase (PAT) for imparting resistance to a Cry1Fa2 toxin and glufosinate), NatureGard (registered trademark), AGRISURE (registered trademark) CB Advantage (Bt11 corn borer (CB) trait), Protecta (registered trademark); and the like.

Also, genetically modified cotton which contains one or more insecticidal genes resistant to harmful insects and develops one or more toxins has been already known and some of cotton have been put on the market. Examples of these genetically modified cotton include BollGard (registered trademark) (cotton variety expressing Cry1Ac toxin), BollGard (registered trademark) II (cotton variety expressing Cry1Ac and Cry2Ab toxins), BollGard (registered trademark) III (cotton variety expressing Cry1Ac, Cry2Ab and VIP3R toxins), VipCot (registered trademark) (cotton variety expressing VIP3A and Cry1Ab toxins), WideStrike (registered trademark) (cotton variety expressing Cry1Ac and Cry1F toxins) and the like.

Examples of the plant used in the present invention also include plants such as soybeans into which a Rag1 (Resistance Aphid Gene 1) gene is introduced to impart resistance to an aphid.

The plants to be used in the present invention include those provided with resistance to nematodes by using a classical breeding method or genetic modification technologies. Examples of the genetic modification technologies used to provide the resistance to nematodes include RNAi.

The above crops include those to which the ability to produce antipathogenic substances having a selective effect is imparted using genetic modification technologies. For example, PR proteins are known as an example of the antipathogenic substance (PRPs, EP-A-0392225). Such antipathogenic substances and genetically modified plants producing these antipathogenic substances are described in, for example, EP-A-0392225, WO 95/33818, and EP-A-0353191. Examples of the antipathogenic substances developed in such genetically modified plants include ion channel inhibitors such as a sodium channel inhibitor and calcium channel inhibitor (KP1, KP4, and KP6 toxins produced by virus are known); stilbene synthase; bibenzyl synthase; chitinase; glucanase; PR protein; antipathogenic substances produced by microorganisms such as peptide antibiotics, antibiotics having a heteroring, and a protein factor (referred to as a plant disease resistant gene and described in WO 03/000906) relating to plant disease resistance.

The above crops include plants to which useful traits such as an oil component reformation and amino acid-content reinforcing trait are given by genetic modification technologies. Examples of these plants include VISTIVE (trademark) (low linolenic soybean having a reduced linolenic content), high-lysine (high oil) corn (corn having an increased lysine or oil content) and the like.

Moreover, the above crops include stuck varieties obtained by combining two or more useful traits such as the above classical herbicide trait or herbicide resistant gene, gene resistant to insecticidal noxious insects, antipathogenic substance-producing gene, oil component reformation, amino acid-content reinforcing trait, and allergen reduction trait.

In the method of the present invention, examples of the compounds of the group B including specific insecticidal compounds, nematicidal compounds, fungicidal compounds, or plant growth regulators used to treat crop seeds or vegetative organs such as tubers, bulbs, or stem fragments include neonicotinoid type compounds, diamide type compounds, carbamate type compounds, organic phosphorous type compounds, biological nematicidal compounds, other insecticidal compounds and nematicidal compounds, azole type compounds, strobilurin type compounds, metalaxyl type compounds, SDHI compounds, and other fungicidal compounds and plant growth regulators.

Examples of the neonicotinoid type compounds in the present invention include the followings:

clothianidin, imidacloprid, nitenpyram, acetamiprid, thiamethoxam, thiacloprid, and dinotefuran.

Examples of the diamide type compounds in the present invention include the followings:

flubendiamide, chlorantraniliprole, cyantraniliprole, and compounds represented by the formula (I):

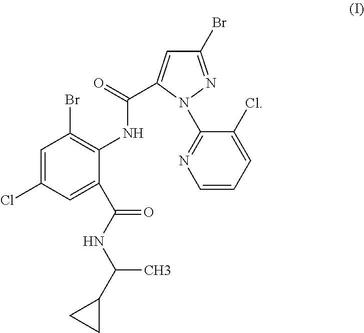 [SMILES: CC(NC(=O)c1cc(Cl)cc(Br)c1NC(=O)c1cc(Br)nn1-c1ncccc1Cl)C1CC1]

Examples of the carbamate type compounds in the present invention include the followings:

aldicarb, oxamyl, thiodicarb, carbofuran, carbosulfan, and dimethoate.

Examples of the organic phosphorous type compounds in the present invention include the followings:

fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon.

Examples of the biological nematicidal compounds in the present invention include the followings:

Harpin Protein, Pasteuria nishizawae, Pasteuria penetrans, Pasteuria usage, Myrothecium verrucaria, Burholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides.

Examples of the other insecticidal compounds and nematicidal compounds in the present invention include the followings:

fipronil, ethiprole, flupyradifurone, sulfoxaflor, beta-cyfluthrin, tefluthrin, chlorpyrifos, abamectin, spirotetramat, and fluensulfone.

Examples of the azole type compounds in the present invention include the followings:

azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, prochloraz, and triflumizol.

Examples of the strobilurin type compounds in the present invention include the followings:

kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxy)methyl]phenyl-2-methoxyacetamide (racemic or enantiomer, containing a mixture of R-enantiomer and S-enantiomer (optional ratio), hereinafter referred to as a compound 1).

Examples of the metalaxyl type compounds include the followings:

metalaxyl and metalaxyl-M and mefenoxam.

Examples of the SDHI compounds in the present invention include the followings:

sedaxane, penflufen, carboxin, boscalid, furametpyr, flutolanil, fluxapyroxad, isopyrazam, fluopyram, and thifluzamide.

Examples of the other fungicidal compounds in the present invention include the followings:

tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine (hereinafter referred to as a compound 2), 3-cyano-5-phenyl-6-methyl-4-(2,6-difluorophenyl)pyridazine (hereinafter referred to as a compound 3), and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio), hereinafter referred to as a compound 4).

Examples of the plant growth regulators in the present invention include the followings:

ethephon, chlormequat-chloride, mepiquat-chloride, and 4-oxo-4-(2-phenylethyl)aminobutyric acid (hereinafter referred to as a compound 5).

In the present invention, the compounds of the group B used to treat crop seeds, or vegetative organs such as tubers, bulbs, or stem fragments are publicly known compounds, and may be synthesized based on well known patent documents. Also, commercially available preparations or standard products may be purchased and used as the compounds of the group B.

In the step of treating crop seeds or vegetative organs such as tubers, bulbs, or stem fragments with the compounds of the group B in the present invention, the compounds of the group B are usually mixed with a carrier such as a solid carrier or liquid carrier and further added with auxiliaries for preparations such as surfactants according to the need to be formulated into preparations. The dosage is preferably an aqueous suspension preparation.

As the compounds of the group B used to treat crop seeds or vegetative organs such as tubers, bulbs, or stem fragments in the present invention, a preparation constituted of a single component may be used, two or more preparations each constituted of a single component may be used in combination, or a preparation constituted of two or more components may be used.

The compounds of the group B used for the above treatment are applied in an amount of usually 0.2 to 5000 g, and preferably 0.5 to 1000 g based on 100 kg of the crop seeds or vegetative organs such as tubers, bulbs, or stem fragments. Examples of a method for applying effective components to the crop seeds or vegetative organs such as tubers, bulbs, or stem fragments include a method in which the crop seeds or vegetative organs such as tubers, bulbs, or stem fragments are powder-coated with a preparation containing effective components; a method in which the crop seeds or vegetative organs such as tubers, bulbs, or stem fragments are dipped in a preparation containing effective components; a method in which a preparation containing effective components is sprayed on the crop seeds or vegetative organs such as tubers, bulbs, or stem fragments; and a method in which the crop seeds or vegetative organs such as tubers, bulbs, or stem fragments are coated with a carrier containing effective components.

The present invention includes the step of treating a crop field with one or more crystals selected from the group consisting of 1^{st} crystal of flumioxazin to 7^{th} crystal of flumioxazin before sowing or planting, at the same time of sowing or planting, or after sowing or planting the crop seeds or vegetative organs such as tubers, bulbs, or stem fragments which are treated with the compounds of the group B.

The 1^{st} crystal of flumioxazin, 2^{nd} crystal of flumioxazin, 3^{rd} crystal of flumioxazin, 4^{th} crystal of flumioxazin, 5^{th} crystal of flumioxazin, 6^{th} crystal of flumioxazin and 7^{th} crystal of flumioxazin (hereinafter, referred to as 1^{st} crystal of flumioxaxin to 7^{th} crystal of flumioxaxin) used in the method of the present invention can be produced by the methods disclosed in Example and modified methods thereof.

The 1^{st} crystal of flumioxaxin to 7^{th} crystal of flumioxaxin in the present invention can be obtained, for example, by conducting the following steps.

First, a starting material is dissolved in an organic solvent to obtain a solution which contains flumioxazin at the concentration generally in the range of 2 mg to 200 mg, preferably in the range of 5 mg to 120 mg, per ml of the solvent, and setting the temperature of the obtained solution generally within the range of 40° C. to 80° C., preferably within the range of 50° C. to 75° C.

Then, the heated solution may be heated to rapidly volatilizing its solvent, for example by dropping the solution onto the heated glass plate or the like to form and isolate crystals.

The heated solvent is preferably cooled to its temperature generally from about 0° C. to less than 25° C., preferably from about 10° C. to 25° C. to form a crystal. Preferably the step of cooling the heated solution is gradually conducted, specifically by lowering the solution preferably at 5° C. to 15° C. per hour, more preferably at around 10° C. per hour. Water or other solvent at the same temperature as that of the heated solution can be added to the solution before cooling for easily forming crystals. After cooling the solution, the cooled solution is maintained at the lowered temperature to form a crystal. The time of maintenance for the solution depends on the scale, temperature or other conditions of the solution, which can be arbitrarily determined.

The crystals of the present invention can be collected in a known manner, for example, by filtration, by concentration, by centrifugation or by decantation. The crystal may be washed with an appropriate solvent, if necessary. The crystal may be subjected to the method comprising the above-mentioned steps or slurry filtration for improving its purity or quality.

It is possible to use, as the starting material for producing the crystal of the present invention, a solution or a suspension of flumioxazin, or a mixture containing flumioxazin. It is also possible to use a solution or a suspension of a synthetic reaction crude product containing flumioxazin.

The organic solvent to be used for the crystallization includes alcohols such as methanol, 2-methoxyethanol, 2-ethoxyethanol, ethers such as tetrahydrofuran, acetone, 1,4-dioxane, halogenated hydrocarbons such as chloroform, 1,2-dichloroethane or chlorobenzene, and aromatic hydrocarbons such as xylene or toluene.

It is also possible to use seed crystals in crystallization for producing the crystal of the present invention. In that case, it is preferred to use crystals having a crystal form to be prepared. The amount of seed crystals to be added is preferably from 0.0005 parts by weight to 0.02 parts by weight, and more preferably from 0.001 part by weight to 0.01 part by weight, based on 1 part by weight of flumioxazin. The crystals of the present invention may be a solvate or a non-solvate.

When a specific hydrophilic organic solvent is used as a crystallization solvent, the obtained crystals are sometimes crystals of a solvate. The crystals of a non-solvate can be obtained by heating to dry the crystals of a solvate under reduced pressure.

The degree of drying of the crystals can be determined by analytical means such as gas chromatography.

It is also possible to determine the purity of the crystal form of the crystal by subjecting the crystal to the powder X-ray diffraction measurement such as CuKα rays diffraction analysis, followed by analyzing the obtained diffraction pattern about the presence or absence of diffraction peaks peculiar to crystal of a solvate, and the height of the peaks.

The crystal of the present invention can be produced with high purity, can remain unchanged in crystal form even after a heat treating step for formulation, can also exhibit physical and chemical properties which are more advantageous for the production of a formulation, and can maintain such properties even after being stored for a long period.

In the step of treating a field with the one or more crystals selected from the group consisting of 1^{st} crystal of flumioxazin to 7^{th} crystal of flumioxazin, the one or more crystals selected from the group consisting of 1^{st} crystal of flumioxazin to 7^{th} crystal of flumioxazin is usually mixed with a carrier such as a solid carrier or liquid carrier and further added with auxiliaries for preparations such as surfactants according to the need to be formulated into preparations.

Examples of a method for applying the one or more crystals selected from the group consisting of 1^{st} crystal of flumioxazin to 7^{th} crystal of flumioxazinto a field include a method in which the one or more crystals selected from the group consisting of 1^{st} crystal of flumioxazin to 7^{th} crystal of flumioxazin is sprayed on field soil and a method in which the one or more crystals selected from the group consisting of 1^{st} crystal of flumioxazin to 7^{th} crystal of flumioxazin is sprayed on weeds after the weeds are grown.

The amount of the one or more crystals selected from the group consisting of 1^{st} crystal of flumioxazin to 7^{th} crystal of flumioxazin used in the step of applying the one or more crystals selected from the group consisting of 1^{st} crystal of flumioxazin to 7^{th} crystal of flumioxazin to a field is usually 5 to 5000 g, preferably 10 to 1000 g, and more preferably 20 to 500 g per 10000 m². In this case, adjuvants may be added to the one or more crystals selected from the group consisting of 1^{st} crystal of flumioxazin to 7^{th} crystal of flumioxazin to apply the one or more crystals selected from the group consisting of 1^{st} crystal of flumioxazin to 7^{th} crystal of flumioxazin to the field.

In the present invention, the crop seeds or vegetative organs such as tubers, bulbs, or stem fragments treated with the compounds of the group B are sowed or planted in a field by a usual method. In the method of controlling pests according to the present invention, a crop field may be treated with the one or more crystals selected from the group consisting of 1^{st} crystal of flumioxazin to 7^{th} crystal of flumioxazin before sowing or planting, at the same time of sowing or planting, or after sowing or planting the crop seeds or vegetative organs such as tubers, bulbs, or stem fragments.

When a crop field is treated with the one or more crystals selected from the group consisting of 1^{st} crystal of flumioxazin to 7^{th} crystal of flumioxazin before sowing or planting the crop seeds or vegetative organs such as tubers, bulbs, or stem fragments, the one or more crystals selected from the group consisting of 1^{st} crystal of flumioxazin to 7^{th} crystal of flumioxazin is applied before 50 days to immediately before sowing or planting, preferably before 30 days to immediately before sowing or planting, more preferably before 20 days to immediately before sowing or planting, and even more preferably before 10 days to immediately before sowing or planting.

When a crop field is treated with the one or more crystals selected from the group consisting of 1^{st} crystal of flumioxazin to 7^{th} crystal of flumioxazin after sowing or planting the crop seeds or vegetative organs such as tubers, bulbs, or stem fragments, the one or more crystals selected from the group consisting of 1^{st} crystal of flumioxazin to 7^{th} crystal of flumioxazin is applied immediately after to 50 days after sowing or planting.

The method of controlling pests according to the present invention ensures that harmful arthropods, noxious nematodes and/or plant pathogens, and pests such as weeds in crop fields can be controlled.

As harmful arthropods, the following examples are given.

Noxious insects belonging to order Hemiptera: Delphacidae such as Laodelphax striatellus, Nilaparvata lugens, and Sogatella furcifera, Deltocephalidae such as Nephotettix cincticeps and Nephotettix virescens, Aphididac such as Aphis gossypii, Myzus persicae, Brevicoryne brassicae, Macrosiphum euphorbiae, Aulacorthum solani, Rhopalosiphum padi, and Toxoptera citricidus, Pentatomidae such as Nezara antennata, Riptortus clavetus, Leptocorisa chinensis, Eysarcoris parvus, Haiyomorpha mista, and Lygus lineolaris, Aleyrodidae such as Trialeurodes vaporariorum, Bemisia tabaci, and Bemisia argentifolii, Coccidae such as Aonidiella aurantii, Comstockaspis perniciosa, Unaspis citri, Ceroplastes rubens, and Icerya purchase, Tingidae, and Psyllidae;

noxious insects belonging to order Lepidoptera: Pyralidae such as Chilo suppressalis, Tryporyza incertulas, Cnaphalocrocis medinalis, Notarcha derogate, Plodia interpunctella, Ostrinia furnacalis, Ostrinia nubilaris, Hellula undalis, and Pediasia teterrellus, Noctuidae such as Spodoptera litura, Spodoptera exigua, Pseudaletia separate, Mamestra brassicae, Agrotis ipsilon, Plusia nigrisigna, Trichoplusia spp., Heliothis spp., and Belicoverpa spp., Pieridae such as Pieris rapae, Tortricidae such as Adoxophyes app., Grapholita molesta, Leguminivora glycinivorella, Matsumuraeses azukivora, Adoxophyes orana fasciata, Adoxophyes sp., Homona magnanima, Archips fuscocupreanus, and Cydia pamonella, Gracillarlidae such as Caloptilia theivora and Phyllonorycter ringoneella, Carposimidae such as Carposina niponensis, hyonetiidae such as Lyonetia spp., Lymantriidae such as Lymantriidae spp. and Euproctis spp., Yponameutidae such as Plutella xylostella, Gelechiidae such as Pectinophora gossypiella and Phthorimaea operculella, Arctiidae such as Hyphantria cunea, and Tineidae such as Tinea translucens and Tineola bisselliella;

noxious insects belonging to order Thripidae: Thysanoptera such as Frankliniella occidentalis, Thrips parmi, Scirtothrips dorsalis, Thrips tabaci, Frankliniella intonsa, and Frankliniella fusca;

noxious insects belonging to order Diptera: Agromyzidae such as Musca domestics, Culex popiens pallens, Tabanus trigonus, Hyleraya antique, Hylemya platura, Anopheles sinensis, Agromyza oryzae, Hydrellia griseola, Chlorops oryzae, and Liriomyza trifolii, Dacus cucurbitae, and Ceratitis capitata;

Noxious insects belonging to order Coleoptera: Epilachna vigintioctopunctata, Aulacophora femoralis, Phyllotreta striolata, Culema oryzae, Echinocnemus squameus, Lissorhoptrus oryzophilus, Anthonomus grandis, Callosobruchus chinensis, Sphenophorus venatus, Popillia japonica, Anomala cuprea, Diabrotica spp., Leptinotarsa decemiineata, Agriotes spp., Lasioderma serricorne, Anthrenus verbasci, Tribolium castaneum, Lyctus brunneus, Anoplophora malasiaca, and Tomicus piniperda;

noxious insects belonging to order Orthoptera: Locusts migratoria, Gryllotalpa africana, Oxya yezoensis, and Oxya japonica;

noxious insects belonging to order Hymenoptera: Athalia rosae, Acromyrmex spp., and Solenopsis spp.;

noxious insects belonging to order Blattodea: Blattella germanica, Periplaneta fuliginosa, Periplaneta americana, Periplaneta brunnea, and Blatta orientalis; and

noxious insects belonging to order Acarina: Tetranychidae such as Tetranychus urticae, Panonychus citri, and Oligonychus spp., Eriophyidae such as Aculops pelekassi, Tarsonemidae such as Polyphagotarsonemus latus, Tenuipalpidae, Tuckerellidae, Acaridae such as Tyrophagus putrescentiae, Dermanyssidae such as Dermatophagoides farina and Dermatophagoides ptrenyssnus, and Cheyletidae such as Cheyletus eruditus, Cheyletus malaccensis, and Cheyletus moorei.

As the plant pathogens, the following examples can be given.

Cercospora gossypina, Cercospora kikuchii, Cercospora zeae-maydis, Cercospora sojina, Phakopsora gossypii, Rhizoctonia solani, Colletotrichum gossypii, Peronospora gossypina, Aspergillus spp., Penicillium spp., Fusarium spp., Tricoderma spp., Thielaviopsis spp., Rhizopus spp., Mucor spp., Corticium spp., Phoma spp., Diplodia spp., Verticillium spp., Puccinia spp., Mycosphaerella spp., Phytophthora spp. (for example, Phytophthora sojae, Phytophthora nicotianae var. nicotianae, Phytophthora infestans, and Phytophthora erythroseptica), Pythium spp. (for example, Pythium debaryanum, Pythium sylvaticum, Pythium graminicola, Pythium irregular, and Pythium ultimum), Microsphaera diffusa, Diaporthe phaseolorum var. sojae, Septoria glycines, Phakopsora pachyrhizi, Sclerotinia sclerotiorum, Elsinoe glycines, Ustilago maydis, Cochliobolus heterostrophus, Gloeocercospora sorghi, and Alternaria spp.

As the weeds, the following examples are given.

Weeds of the family Urticaceae: Urtica urens;

weeds of the family Polygonaceae: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicas, Rumex crispus, Rumex obtusifolius, and Rumex acetosa;

weeds of the family Portulacaceae: Portulaca oleracea;

weeds of the family Caryophyllaceae: Stellaria media, Cerastium holosteoides, Cerastium glomeratum, Spergula arvensis, and Silene gallica;

weeds of the family Molluginaceae: Mollugo verticillata;

weeds of the family Chenopodiaceae: Chenopodium album, Chenopodium ambrosioides, Kochia scoparia, Salsola kali, and Atriplex spp.;

weeds of the family Amaranthaceae: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, and Alternanthera tenella;

weeds of the family Papaveraceae: Papaver rhoeas and Argemone mexicana;

weeds of the family Brassicaceae: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, and Coronopus didymus;

weeds of the family Capparaceae: Cleome affinis;

weeds of the family Fabaceae: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Viola angustifolia, Indigofera hirsute, Indigofera truxillensis, and Vigna sinensis;

weeds of the family Oxalidaceae: Oxalis corniculate, Oxalis strica, and Oxalis oxyptera;

weeds of the family Geraniaceae: Geranium carolinense and Erodiura cicutarium;

weeds of the family Euphorbiaceae: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, and Ricinus communis;

weeds of the family Malvaceae: Abutilon theophrasti, Sida rhonibiforia, Sida cordifolia, Sida spinosa, Sida glaziovii, Sida santaremnensis, Hibiscus trionum, Anoda cristata, and Malvastrum coromandelianum;

weeds of the family Sterculiaceae: Waltheria indica;

weeds of the family Violaceae: Viola arvensis, and Viola tricolor;

weeds of the family Cucurbitaceae: Sicyos angulatus, Echinocystis lobata, and Momordica charantia;

weeds of the family Lythraceae: Lythrum salicaria;

weeds of the family Apiaceae: Hydrocotyle sibthorpioides;

weeds of the family Sapindaceae: Cardiospermum halicacabum;

weeds of the family Primulaceae: Anagallis arvensis;

weeds of the family Asclepiadaceae: Asclepias syriaca and Ampelamus albidus;

weeds of the family Rubiaceae: Galium aparine, Galium spuriura var. echinospermon, Spermacoce latifolia, Richardia brasiliensis, and Borreria alata;

weeds of the family Convolvulaceae: Ipomoea nil, Ipomoea hederacea, Ipomoea purpurea, Ipomoea hederacea var. integriuscula, Ipomoea lacunose, Ipomoea triloba, Ipomoea acuminate, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoids, and Jacquemontia tamnifolia;

weeds of the family Boraginaceae: Myosotis arvensis;

weeds of the family Lamiaceae: Lamium purpureum, Lamium amplexicaule, Leonotis nepetaefolia, Hyptis suaveolens, Hyptis lophanta, Leonurus sibiricus, and Stachys arvensis;

weeds of the family Solanaceae: Datura stramonium, Solanum nigrum, Solanum americanum, Solarium ptycanthum, Solanum sarrachoides, Solanum rostratum, Solanum aculeatissimuru, Solanum sisymbriifolium, Solarium carolinense, Physalis angulata, Physalis subglabrata, and Nicandra physaloides;

weeds of the family Scrophulariaceae: Veronica hederaefolia, Veronica persica, and Veronica arvensis;

weeds of the family Plantaginaceae: Plantago asiatica;

weeds of the family Asteraceae: Xanthium pensylvanicum, Xanthium occidentale, Helianthus annuus, Matricaria chamomilla, Matricaria perforate, Chrysanthemum segetum, Matricaria matricaricides, Artemisia princeps, Artemisia vulgaris, Artemisia verlotorum, Solidago altissima, Taraxacum officinale, Galinsoga ciliate, Galinsoga parviflora, Senecio vulgaris, Senecio brasiliensis, Senecio grisebachii, Conyza bonariensis, Conyza Canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodiumperfoliaturn, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, and Soliva sessilis;

weeds of the family Liliaceae: Allium canadense and Allium vineale;

weeds of the family Commelinaceae: Commelina communis, Commelina bengharensis, and Commelina erecta;

weeds of the family Poaceae: Echinochloa crus-galli, Setaria viridis, Setaria faberi, Setaria glauca, Setaria geniculate, Digitaria ciliaris, Digitaria sanguinalis, Digitaria horizontalis, Digitaria insularis, Eleusine indica, Poaannua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, and Rottboellia cochinchinensis;

weeds of the family Cyperaceae: Cyperus microiria, Cyperus iria, Cyperus odoratus, Cyperus rotundus, Cyperus esculentus, and Kyllinga gracillima; and

weeds of the family Equisetaceae: Equisetum arvense and Equisetum palustre.

In the method of the present invention, one or more other agrochemicals may be used in combination with the compounds of the group B or the one or more crystals selected from the group consisting of 1^{st} crystal of flumioxazin to 7^{th} crystal of flumioxazin either simultaneously or separately. Examples of the other agrochemicals include insecticides, acaricides, nematicides, fungicides, herbicides, plant growth regulators, and safeners.

As the above herbicides, plant growth regulators, and safeners, the following examples are given.

Herbicides: pyrithiobac, pyrithiobac-sodium salt, pyriminobac, pyriminobac-methyl, bispyribac, bispyribac-sodium salt, pyribenzoxim, pyrimisulfan, pyriftalid, triafamone, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium salt, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, ipfencarbazone, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropyl-ammonium salt, imazaquin, imazaquin-ammonium salt, imazethapyr, imazethapyr-ammonium salt, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, azafenidin, oxadiazon, oxadiargyl, carfentrazone, carfentrazone-ethyl, saflufenacil, cinidon, cinidon-ethyl, sulfentrazone, pyraclonil, pyraflufen, pyraflufen-ethyl, butafenacil, fluazolate, fluthiacet, fluthiacet-methyl, flufenpyr, flufenpyr-ethyl, flumiclorac, flumiclorac-pentyl, pentoxazone, oxyfluorfen, acifluorfen, aclonifen, chlomethoxynil, chloronitrofen, nitrofen, bifenox, fluoroglycofene, fluoroglycofene-ethyl, fomesafen, fomesafen-sodium salt, lactofen, benzobicyclon, bicyclopyrone, mesotrione, sulcotrione, tefuryltrione, tembotrione, isoxachlortole, isoxaflutole, benzofenap, pyrasulfotole, pyrazolynate, pyrazoxyfen, topramezone, diflufenican, picolinafen, beflubutamid, norflurazon, fluridone, fluorochloridone, flurtamone, ioxynil, ioxynil octanoate, bentazone, pyridate, bromoxynil, bromoxynil octanoate, chlorotoluron, dimefuron, diuron, linuron, fluometuron, isoproturon, isouron, tebuthiuron, benzthiazuron, methabenzthiazuron, propanil, metobromuron, metoxuron, monolinuron, siduron, simazine, atrazine, propazine, cyanazine, ametryn, simetryn, dimethametryn, prometryn, terbumeton, terbuthylazine, terbutryn, trietazine, hexazinone, metamitron, metribuzin, amicarbazone, bromacil, lenacil, terbacil, chlcridazon, desmedipham, phenmedipham, propachior, metazachlor, alachlor, acetochlor, metolachlor, S-metolachlor, butachler, pretilachlor, thenylchlor, indanofan, cafenstrole, fentrazamide, dimethenamid, dimethenamid-P, mefenacet, pyroxasulfone, fenoxasulfone, naproanilide, anilofos, flufenacet, trifluralin, pendimethalin, ethafluralin, benfluralin, prodiamine, indaziflam, triaziflam, butamifos, dithiopyr, thiazopyr, dicamba and a salt thereof (diglycolamine salt, dimethylammonium salt, isopropylammonium salt, potassium salt, sodium salt, and choline salt), 2,4-D and a salt or ester thereof (butotyl ester, dimethylammonium salt, diolamine salt, ethylhexyl ester, isooctyl ester, isopropylammoniumsalt, sodium salt, and triisopropanolamine salt), 2,4-DB and a salt or ester thereof (dimethylammonium salt, isooctyl ester, and choline salt), MCPA and a salt or ester thereof (dimethylammonium salt, 2-ethylhexylester, isooctyl ester, sodium salt, and choline salt), MCPB, mecopropand a salt or ester thereof (dimethylammonium salt, diolamine salt, ethadyl ester, 2-ethylhexyl ester, isooctyl ester, methyl ester, potassium salt, sodium salt, tololamine salt, and choline salt), mecoprop-P and a salt or ester thereof (dimethylammonium salt, 2-ethylhexyl ester, isobutyl salt, potassium salt, and choline salt), dichlorprop and a salt or ester thereof (butotyl ester, dimethylammonium salt, 2-ethylhexyl ester, isooctyl ester, methyl ester, potassium salt, sodium salt, and choline salt), dichlorprop-P, dichlorprop-P dimethylammonium salt, triclopyr and a salt or ester thereof (butotyl ester and triethylammonium salt), fluoroxypyr, fluoroxypyr-meptyl, picloram and a salt thereof (potassium salt, triisopanolammonium salt, and choline salt), quinclorac, quinmerac, aminopyralid and a salt thereof (potassium salt, triisopanolammonium salt, and choline salt), clopyralid and a salt thereof (olamine salt, potassium salt, triethylammonium salt, and choline salt), clomeprop, glufosinate, glufosinate-ammonium salt, glufosinate-P, glufosinate-P-sodium salt, bialaphos, isoxaben, dichlobenil, methiozolin, diallate, butylate, triallate, chlorpropham, asulam, phenisopham, benthiocarb, molinate, esprocarb, pyributicarb, prosulfocarb, orbencarb, EPTC, dimepiperate, swep, aminocyclopyrachlor, aminocyclopyrachlor-methyl, aminocyclopyrachlor-potassium, difenoxuron, methyl dymron, bromobutide, dymron, cumyluron, diflufenzopyr, etobenzanide, tridiphane, amitrole, fenchlorazole, clomazone, maleic acid hydrazide, oxaziclomefone, cinmethylin, benfuresate, ACN, dalapon, chlorthiamid, flupoxam, bensulide, paraquat, paraquat-dichloride, diquat, and diquat-dibromide.

Plant growth regulators: hymexazol, paclobutrazol, uniconazole, uniconazole-P, inabenfide, prohexadione-calcium, 1-methylcyclopropene, and trinexapac.

Safeners: benoxacor, cloquintocet, cloquintocet-mexyl, cyometrinil, cyprosulfamide, dichlormid, dicyclonon, dietholate, fenchlorazole, fenchlorazole-ethyl, fenclorim, flurazole, fluxofenim, furilazole, isoxadifen, isoxadifen-ethyl, mefenpyr, mefenpyr-diethyl, mephenate, naphthalic anhydride, and oxabetrinil.

In the method of the present invention, a glufosinate-ammonium salt, chlorimuron-ethyl, cloransulam-methyl, pyroxasulfone, imazethapyr-ammonium salt, metribuzin, 2,4-D, 2,4-D-butotyl ester, 2,4-D-dimethylammonium salt, 2,4-D-diolamine salt, 2,4-D-ethylhexyl ester, 2,4-D-isooctyl ester, 2,4-D-isopropylammonium salt, 2,4-D-sodium salt, 2,4-D-triisopropanolamine salt, dicamba, dicamba-diglycolamine salt, dicamba-dimethylammonium salt, dicamba-isopropylammonium salt, dicamba-potassium salt, dicamba-sodium salt, dicamba-choline salt, mesotrione, tembotrione, isoxaflutole, and ametryn are particularly preferable as the herbicides which may be simultaneously used in combination with the one or more crystals selected from the group consisting of 1^{st} crystal of flumioxazin to 7^{th} crystal of flumioxazin.

In the present invention, cyprosulfamide, mefenpyr-diethyl, and isoxadifen-ethyl are particularly preferable as the safener which may be simultaneously used in combination with the one or more crystals selected from the group consisting of 1^{st} crystal of flumioxazin to 7^{th} crystal of flumioxazin.

The followings are more preferable as the combinations of the herbicide and/or safener which may be used in combination with the one or more crystals selected from the group consisting of 1^{st} crystal of flumioxazin to 7^{th} crystal of flumioxazin:

a combination of one or more crystals selected from the group consisting of 1^{st} crystal of flumioxazin to 7^{th} crystal of flumioxazin and glufosinate-ammonium salt;

a combination of one or more crystals selected from the group consisting of 1^{st} crystal of flumioxazin to 7^{th} crystal of flumioxazin and chlorimuron-ethyl;

a combination of one or more crystals selected from the group consisting of 1^{st} crystal of flumioxazin to 7^{th} crystal of flumioxazin and cloransulam-methyl;

a combination of one or more crystals selected from the group consisting of 1^{st} crystal of flumioxazin to 7^{th} crystal of flumioxazin, chlorimuron-ethyl, and pyroxasulfone;

a combination of one or more crystals selected from the group consisting of 1^{st} crystal of flumioxazin to 7^{th} crystal of flumioxazin and pyroxasulfone;

a combination of one or more crystals selected from the group consisting of 1^{st} crystal of flumioxazin to 7^{th} crystal of flumioxazin and imazethapyr-ammonium salt;

a combination of one or more crystals selected from the group consisting of 1^{st} crystal of flumioxazin to 7^{th} crystal of flumioxazin and metribuzin;

a combination of one or more crystals selected from the group consisting of 1^{st} crystal of flumioxazin to 7^{th} crystal of flumioxazin and 2,4-D;

a combination of one or more crystals selected from the group consisting of 1^{st} crystal of flumioxazin to 7^{th} crystal of flumioxazin and 2,4-D-butotyl ester;

a combination of one or more crystals selected from the group consisting of 1^{st} crystal of flumioxazin to 7^{th} crystal of flumioxazin and 2,4-D-dimethylammonium salt;

a combination of one or more crystals selected from the group consisting of 1^{st} crystal of flumioxazin to 7^{th} crystal of flumioxazin and 2,4-D-diolamine salt;

a combination of one or more crystals selected from the group consisting of 1^{st} crystal of flumioxazin to 7^{th} crystal of flumioxazin and 2,4-D-ethylhexyl ester;

a combination of one or more crystals selected from the group consisting of 1^{st} crystal of flumioxazin to 7^{th} crystal of flumioxazin and 2,4-D-isooctyl ester;

a combination of one or more crystals selected from the group consisting of 1^{st} crystal of flumioxazin to 7^{th} crystal of flumioxazin and 2,4-D-isopropylammonium salt;

a combination of one or more crystals selected from the group consisting of 1^{st} crystal of flumioxazin to 7^{th} crystal of flumioxazin and 2,4-D-sodium salt;

a combination of one or more crystals selected from the group consisting of 1^{st} crystal of flumioxazin to 7^{th} crystal of flumioxazin and 2,4-D-triisopropanolamine salt;

a combination of one or more crystals selected from the group consisting of 1^{st} crystal of flumioxazin to 7^{th} crystal of flumioxazin and dicamba;

a combination of one or more crystals selected from the group consisting of 1^{st} crystal of flumioxazin to 7^{th} crystal of flumioxazin and dicamba-diglycolamine salt;

a combination of one or more crystals selected from the group consisting of 1^{st} crystal of flumioxazin to 7^{th} crystal of flumioxazin and dicamba-dimethylammonium salt;

a combination of one or more crystals selected from the group consisting of 1^{st} crystal of flumioxazin to 7^{th} crystal of flumioxazin and dicamba-isopropylammonium salt;

a combination of one or more crystals selected from the group consisting of 1^{st} crystal of flumioxazin to 7^{th} crystal of flumioxazin and dicamba-potassium salt;

a combination of one or more crystals selected from the group consisting of 1^{st} crystal of flumioxazin to 7^{th} crystal of flumioxazin and dicamba-sodium salt;

a combination of one or more crystals selected from the group consisting of 1^{st} crystal of flumioxazin to 7^{th} crystal of flumioxazin and dicamba-choline salt;

a combination of one or more crystals selected from the group consisting of 1^{st} crystal of flumioxazin to 7^{th} crystal of flumioxazin, dicamba, and isoxadifen-ethyl;

a combination of one or more crystals selected from the group consisting of 1^{st} crystal of flumioxazin to 7^{th} crystal of flumioxazin, dicamba-diglycolamine salt, and isoxadifen-ethyl;

a combination of one or more crystals selected from the group consisting of 1^{st} crystal of flumioxazin to 7^{th} crystal of flumioxazin, dicamba-dimethylammonium salt, and isoxadlfen-ethyl;

a combination of one or more crystals selected from the group consisting of 1^{st} crystal of flumioxazin to 7^{th} crystal of flumioxazin, dicamba-isopropylammonium salt, and isoxadifen-ethyl;

a combination of one or more crystals selected from the group consisting of 1^{st} crystal of flumioxazin to 7^{th} crystal of flumioxazin, dicamba-potassium salt, and isoxadifen-ethyl;

a combination of one or more crystals selected from the group consisting of 1^{st} crystal of flumioxazin to 7^{th} crystal of flumioxazin, dicamba-sodium salt, and isoxadifen-ethyl;

a combination of one or more crystals selected from the group consisting of 1^{st} crystal of flumioxazin to 7^{th} crystal of flumioxazin, dicamba-choline salt, and isoxadifen-ethyl;

a combination of one or more crystals selected from the group consisting of 1^{st} crystal of flumioxazin to 7^{th} crystal of flumioxazin and mesotrione;

a combination of one or more crystals selected from the group consisting of 1^{st} crystal of flumioxazin to 7^{th} crystal of flumioxazin and tembotrione;

a combination of one or more crystals selected from the group consisting of 1^{st} crystal of flumioxazin to 7^{th} crystal of flumioxazin and isoxaflutole;

a combination of one or more crystals selected from the group consisting of 1^{st} crystal of flumioxazin to 7^{th} crystal of flumioxazin and ametryn;

a combination of one or more crystals selected from the group consisting of 1^{st} crystal of flumioxazin to 7^{th} crystal of flumioxazin, isoxaflutole, and cyprosulfamide;

a combination of one or more crystals selected from the group consisting of 1^{st} crystal of flumioxazin to 7^{th} crystal of flumioxazin, tembotrione, and isoxadifen; and

a combination of one or more crystals selected from the group consisting of 1^{st} crystal of flumioxazin to 7^{th} crystal of flumioxazin and saflufenacil.

### EXAMPLES

Hereinbelow, the present invention will be described in detail by way of examples, but the present invention is not limited to these examples.

### Production Example

Production Example of 1^{st} crystal of flumioxazin to 7^{th} crystal of flumioxazin used in the method of the present invention will be shown below.

### Production Example 1

The powder X-ray diffraction patterns of the obtained crystals were measured by X′Pert Pro MPD (manufactured by PANalytical B.V., Netherlands) at a scanning range from 2.0° to 40.0° (20) using CuKα rays (40 kV, 30 mA).

### Production Example 1

Flumioxazin (100 mg) was dissolved in 2-methoxyethanol at 60° C. so as to adjust its concentration to 16.8 mg/mL. Then 10 times volumes of water relative to the volume of 2-methoxyethanol were heated to 60° C. and gradually added to the obtained solution. The obtained mixture was gradually cooled to 20° C. at the rate of 10° C. per hour and then left to stand, followed by filtrating it to collect crystals.

The pattern of the obtained crystals had the peaks with 2θ values as shown in Table 2 to find them 1^{st} crystals of flumioxazin.

TABLE 2

| 2θ value (°) | d value (Å) | Relative intensity (%) |
|---|---|---|
| 7.5 | 11.7774 | 22.5 |
| 11.9 | 7.4308 | 61.9 |
| 15.3 | 5.8241 | 11.0 |

The 1^{st} crystals of flumioxazin were obtained by the same method as mentioned above except that methanol or 2-ethoxyethanol was used instead of 2-methoxyethanol.

### Production Example 2

Flumioxazin (100 mg) was dissolved in tetrahydrofuran [THF] at 60° C. so as to adjust its concentration to 51.0 mg/mL. The obtained mixture was gradually dropped onto a glass plate heated at 100° C. to rapidly volatilize its solvent therefrom, to obtain crystals.

The pattern of the obtained crystals had the peaks with 2θ values as shown in Table 3 to find them 2^{nd} crystals of flumioxazin

TABLE 3

| 2θ value (°) | d value (Å) | Relative intensity (%) |
|---|---|---|
| 8.7 | 10.1555 | 20.4 |
| 9.4 | 9.4007 | 43.5 |
| 14.7 | 6.0211 | 62.0 |
| 18.8 | 4.7162 | 100.0 |

The 2^{nd} crystals of flumioxazin were obtained by the same method as mentioned above except that acetone was used instead of THF. The crystals were obtained by adding methanol instead of THF to flumioxazin, gradually cooling to 20° C., followed by leaving it to stand.

### Production Example 3

Flumioxazin (100 mg) was dissolved in 1,2-dichloroethane at 60° C. so as to adjust its concentration to 50.9 mg/mL. Then the obtained solution was gradually cooled to 20° C. at the rate of 10° C. per hour and then left to stand, followed by blow its solvent with nitrogen gas to obtain crystals.

The pattern of the obtained crystals had the peaks with 2θ values as shown in Table 4 to find them 3^{rd} crystals of flumioxazin.

TABLE 4

| 2θ value (°) | d value (Å) | Relative intensity (%) |
|---|---|---|
| 7.7 | 11.4720 | 100.0 |
| 10.9 | 8.1102 | 21.5 |
| 13.5 | 6.5535 | 41.1 |
| 14.6 | 6.0621 | 9.5 |
| 15.0 | 5.9013 | 12.6 |

The 3^{rd} crystals of flumioxazin were obtained by the same method as mentioned above except that chlorobenzene was used instead of 1,2-dichloroethane

### Production Example 4

Flumioxazin (100 mg) was dissolved in toluene at 60° C. so as to adjust its concentration to 13.3 mg/mL. Then the obtained solution was gradually cooled to 20° C. at the rate of 10° C. per hour and then left to stand, followed by blow its solvent with nitrogen gas to obtain crystals.

The pattern of the obtained crystals had the peaks with 2θ values as shown in Table 5 to find them 4^{th} crystals of flumioxazin.

TABLE 5

| 2θ value (°) | d value (Å) | Relative intensity (%) |
|---|---|---|
| 7.7 | 5.9013 | 100.0 |
| 10.7 | 8.2613 | 13.9 |
| 13.4 | 6.6022 | 25.5 |
| 14.3 | 6.1886 | 4.6 |
| 14.8 | 5.9806 | 6.8 |

### Production Example 5

Flumioxazin 100 mg) was dissolved in xylene at 60° C. so as to adjust its concentration to 10.0 mg/mL. Then the obtained solution was gradually cooled to 20° C. at the rate of 10° C. per hour and then left to stand, followed by blow its solvent with nitrogen gas at 20° C. to obtain crystals.

The pattern of the obtained crystals had the peaks with 2θ values as shown in Table 6 to find them 5^{th} crystals of flumioxazin.

TABLE 6

| 2θ value (°) | d value (Å) | Relative intensity (%) |
|---|---|---|
| 5.5 | 16.0548 | 23.1 |
| 10.3 | 8.5812 | 68.2 |
| 10.9 | 8.1102 | 29.7 |
| 13.2 | 6.7018 | 37.6 |

### Production Example 6

Flumioxazin (100 mg) was dissolved in chloroform at 60° C. so as to adjust its concentration to 102.8 mg/mL. The chloroform solution was added gradually to 10 times volumes of heptane relative to the volume of chloroform at 60° C. The obtained mixture was gradually cooled to 20° C. at the rate of 10° C. per hour and then left to stand, followed by filtrating it to collect crystals.

The pattern of the obtained crystals had the peaks with 2θ values as shown in Table 7 to find them 6^{th} crystals of flumioxazin.

TABLE 7

| 2θ value (°) | d value (Å) | Relative intensity (%) |
|---|---|---|
| 7.7 | 11.4720 | 100.0 |
| 8.6 | 10.2733 | 5.8 |
| 11.0 | 8.0367 | 14.4 |
| 13.2 | 6.7018 | 6.7 |
| 14.7 | 6.0211 | 7.4 |
| 15.1 | 5.8625 | 9.2 |

The 6^{th} crystals of flumioxazin were obtained by the same method as mentioned above except that THF was used instead of chloroform.

The solution obtained by adding 2 times volumes of THF relative to the volume of chloroform to flumioxazin instead of chloroform, was added to 10 times volumes of water relative to the volume of THF and gradually cooled to 20° C., followed by leaving it to stand.

The crystals were obtained by adding THF, 1,4-dioxane or pyridine instead of chloroform to flumioxazin and, gradually cooling to 20° C., followed by concentrating it.

### Production Example 7

Flumioxazin (100 mg) was dissolved in 1,4-dioxane at 60° C. so as to adjust its concentration to 50.9 mg/mL. The 1,4-dioxane solution was added gradually to 10 times volumes of water relative to the volume of 1,4-dioxane at 60° C. The obtained mixture was gradually cooled to 20° C. at the rate of 10° C. per hour and then left to stand, followed by filtrating it to collect crystals.

The pattern of the obtained crystals had the peaks with 2θ values as shown in Table 8 to find them 7^{th} crystals of flumioxazin.

TABLE 8

| 2θ value (°) | d value (Å) | Relative intensity (%) |
|---|---|---|
| 14.5 | 6.1037 | 15.6 |
| 18.7 | 4.7412 | 36.4 |

The 7^{th} crystals of flumioxazin were obtained by the same method as mentioned above except that heptane was used instead of water.

### Test Examples

First, given are the standard of evaluation of a pest control effect (harmful arthropod control effect, plant pathogen control effect, and herbicidal effect) and that of crop injuries, which will be shown in examples hereinafter.

[Harmful Arthropod Control Effect]

In the evaluation of the harmful arthropod control effect, each insect at the time of investigation is examined by discriminating whether the insect is alive or dead to calculate a controlling value by the following equation.

Controlling value (%)=100×(1−T/C)

wherein C represents the number of insects to be observed in an untreated area, and

T represents the number of insects to be observed in a treated area

[Plant Pathogen Control Effect]

In the evaluation of the plant pathogen control effect, the symptom of each test plant in a treated area is compared with that in an untreated area and when there is no or almost no difference in symptom between the treated area and the untreated area at the time of investigation, the case is given “0”, and when no or almost no change in symptom caused by plant pathogens is observed at the time of investigation, the case is given “100”, thereby grading each sample between 0 to 100.

[Herbicidal Effect and Crop Injuries]

In the evaluation of the herbicidal effect, the germination or growth condition of each test weed in a treated area is compared with that in an untreated area and when there is no or almost no difference in germination or growth condition between the treated area and the untreated area at the time of investigation, the case is given “0”, and when the test plant perfectly withers and dies, or the germination or growth of the plant is perfectly restricted at the time of investigation, the case is given “100”, thereby grading each sample between 0 to 100.

In the evaluation of crop injuries, the case where almost no crop injury is observed is expressed as “harmless”, the case where mild crop injuries are observed is expressed as “small”, the case where moderate crop injuries are observed is expressed as “middle”, and the case where severe crop injuries are observed is expressed as “large”.

### Example 1

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200 g/ha. After 15 days, cottonseeds are sowed to which one or more compounds selected from the group B are attached at a dose of 1, 10, or 100 g/100 kg seeds. This pot is placed in a greenhouse. The pest control effect and crop injuries are examined 15 days after the seeds are sowed.

### Example 2

One or more compounds selected from the group B are attached to cotton seeds at a dose of 1, 10, or 100 g/100 kg seeds. Next, the seeds are sowed in a cultivated field. Stem leaves of the weed are directly treated with one or more crystals selected from the group consisting of 1^{st} crystal of flumioxazin to 7^{th} crystal of flumioxazin at a dose of 25, 50, 100, 200, or 400 g/ha in the condition of the cotton main stem being lignified at a length of 15 cm from the surface of the ground 30 days after these seeds are sowed. The pest control effect and crop injuries are examined 28 days after the treatment.

### Example 3

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200 g/ha. After 7 days, soybean seeds are sowed to which one or more compounds selected from the group B are attached at a dose of 1, 10, or 100/100 kg seeds. This pot is placed in a greenhouse. The pest control effect and crop injuries are examined 15 days after the seeds are sowed.

### Example 4

One or more compounds selected from the group B are attached to soybean seeds at a dose of 1, 10, or 100 g/100 kg seeds. Next, a pot is filled with soil and the soybean seeds and weed seeds are sowed. On the day of sawing, the surface of the soil is uniformly treated with one or more crystals selected from the group consisting of 1^{st} crystal of flumioxazin to 7^{th} crystal of flumioxazin at a dose of 25, 50, 100, or 200 g/ha. This pot is placed in a greenhouse. The pest control effect and crop injuries are examined 15 days after the seeds are sowed.

### Example 5

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200 g/ha. After 7 days, corn seeds are sowed to which one or more compounds selected from the group B are attached at a dose of 1, 10, or 100 g/100 kg seeds. This pot is placed in a greenhouse. The pest control effect and crop injuries are examined 15 days after the seeds are sowed.

### Example 6

One or more compounds selected from the group B are attached to corn seeds at a dose of 1, 10, or 100 g/100 kg seeds. Next, a pot is filled with soil and the corn seeds and weed seeds are sowed. On the day of sowing, the surface of the soil is uniformly treated with one or more crystals selected from the group consisting of 1^{st} crystal of flumioxazin to 7^{th} crystal of flumioxazin at a dose of 25, 50, 100, or 200 g/ha. This pot is placed in a greenhouse. The pest control effect and crop injuries are examined 15 days after the seeds are sowed.

### Example 7

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200 g/ha. After 15 days, wheat seeds are sowed to which one or more compounds selected from the group B are attached at a dose of 1, 10, or 100 g/100 kg seeds. This pot is placed in a greenhouse. The pest control effect and crop injuries are examined 15 days after the seeds are sowed.

### Example 8

A pot is filled with soil and weeds are sowed, and the surface of the soil is uniformly treated with one or more crystals selected from the Group consisting of 1^{st} crystal of flumioxazin to 7^{th} crystal of flumioxazin at a dose of 25, 50, 100, or 200 g/ha. After 15 days, tomato seeds are sowed to which one or more compounds selected from the group B are attached at a dose of 1, 10, or 100 g/100 kg seeds. This pot is placed in a greenhouse. The pest control effect and crop injuries are examined 15 days after the tomato seeds are sowed.

### Example 9

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200 g/ha. After 15 days, eggplant seeds are sowed to which one or more compounds selected from the group B are attached at a dose of 1, 10, or 100 g/100 kg seeds. This pot is placed in a greenhouse. The pest control effect and crop injuries are examined 15 days after the eggplant seeds are sowed.

### Example 10

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200 g/ha. After 15 days, bell pepper seeds are sowed to which one or more compounds selected from the group B are attached at a dose of 1, 10, or 100 g/100 kg seeds. This pot is placed in a greenhouse. The pest control effect and crop injuries are examined 15 days after the bell pepper seeds are sowed.

### Example 11

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, 200, or 400 g/ha. After 15 days, sugar cane stem fragments are planted to which one or more compounds selected from the group B at a dose of 1, 10, or 100 g/100 kg stem fragments. This pot is placed in a greenhouse. The peat control effect and crop injuries are examined 15 days after the sugar cane stem fragments are planted.

### Example 12

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200 g/ha. After 15 days, common bean seeds are sowed to which one or more compounds selected from the group B are attached at a dose of 1, 10, or 100 g/100 kg seeds. This pot is placed in a greenhouse. The pest control effect and crop injuries are examined 15 days after the common bean seeds are sowed.

### Example 13

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200/ha. After 15 days, rice seeds are sowed to which one or more compounds selected from the group B are attached at a dose of 1, 10, or 100 g/100 kg seeds. This pot is placed in a greenhouse. The pest control effect and crop injuries are examined 15 days after the rice seeds are sowed.

### Example 14

A pot is filled with soil and weeds are sowed, and the surface of the soil is uniformly treated with one or more crystals selected from the group consisting of 1^{st} crystal of flumioxazin to 7^{th} crystal of flumioxazin at a dose of 25, 50, 100, or 200 g/ha. After 15 days, rapeseeds are sowed to which one or more compounds selected from the group B are attached at a dose of 1, 10, or 100 g/100 kg seeds. This pot is placed in a greenhouse. The pest control effect and crop injuries are examined 15 days after the rapeseeds are sowed.

### Example 15

One or more compounds selected from the group B are attached to sugar cane stem fragments at a dose of 1, 10, or 100 g/100 kg stem fragments. Then, the stem fragments are planted in a cultivated field. When the plant height of the sugar cane becomes 60 cm or higher after the stem fragments are planted, stem leaves of the weed are directly treated with one or more crystals selected from the group consisting of 1^{st} crystal of flumioxazin to 7^{th} crystal of flumioxazin at a dose of 25, 50, 100, 200, or 400 g/ha. The pest control effect and crop injuries are examined 28 days after the treatment.

### Example 16

One or more compounds selected from the group B are attached to peanut seeds at a dose of 1, 10, or 100 g/100 kg seeds. Next, a pot is filled with soil and the peanut seeds and weed seeds are sowed. On the day of sowing, the surface of the soil is uniformly treated with one or more crystals selected from the group consisting of 1^{st} crystal of flumioxazin to 7^{th} crystal of flumioxazin at a dose of 25, 50, 100, or 200 g/ha. This pot is placed in a greenhouse. The pest control effect and crop injuries are examined 15 days after the seeds are sowed.

### Example 17

One or more compounds selected from the group B are attached to common bean seeds at a dose of 1, 10, or 100 g/100 kg seeds. Next, a pot is filled with soil and the common bean seeds and weed seeds are sowed. On the day of sowing, the surface of the soil is uniformly treated with one or more crystals selected from the group consisting of 1^{st} crystal of flumioxazin to 7^{th} crystal of flumioxazin at a dose of 25, 50, 100, or 200 g/ha. This pot is placed in a greenhouse. The pest control effect and crop injuries are examined 15 days after the seeds are sowed.

### Example 18

One or more compounds selected from the group B are attached to pea seeds at a dose of 1, 10, or 100 g/100 kg seeds. Next, a pot is filled with sail and the pea seeds and weed seeds are sowed. On the day of sowing, the surface of the soil is uniformly treated with one or more crystals selected from the group consisting of 1^{st} crystal of flumioxazin to 7^{th} crystal of flumioxazin at a dose of 25, 50, 100, or 200/ha. This pot is placed in a greenhouse. The pest control effect and crop injuries are examined 15 days after the seeds are sowed.

### Example 19

One or more compounds selected from the group B are attached to sunflower seeds at a dose of 1, 10, or 100 g/100 kg seeds. Next, a pot is filled with soil and the sunflower seeds and weed seeds are sowed. On the day of sowing, the surface of the soil is uniformly treated with one or more crystals selected from the group consisting of 1^{st} crystal of flumioxazin to 7^{th} crystal of flumioxazin at a dose of 25, 50, 100, or 200 g/ha. This pot is placed in a greenhouse. The pest control effect and crop injuries are examined 15 days after the seeds are sowed.

### Example 20

One or more compounds selected from the group B are attached to sugar cane stem fragments at a dose of 1, 10, or 100 g/100 kg stem fragments. Next, a pot is filled with soil, then weed seeds are sowed and the stem fragments are planted. On the day of sowing and planting, the surface of the soil is uniformly treated with one or more crystals selected from the group consisting of 1^{st} crystal of flumioxazin to 7^{th} crystal of flumioxazin at a dose of 25, 50, 100, 200, or 400 g/ha. This pot is placed in a greenhouse. The pest control effect and crop injuries are examined 15 days after sowing and planting.

### Example 21

One or more compounds selected from the group B are attached to potato tubers at a dose of 1, 10, or 100 g/100 kg tubers. Next, a pot is filled with soil, then weed seeds are sowed and the tubers are planted. On the day of sowing and planting, the surface of the soil is uniformly treated with one or more crystals selected from the group consisting of 1^{st} crystal of flumioxazin to 7^{th} crystal of flumioxazin at a dose of 12.5, 25, 50, or 100 g/ha. This pot is placed in a greenhouse. The pest control effect and crop injuries are examined 15 days after sowing and planting.

### Example 22

One or more compounds selected from the group B are attached to onion seeds at a dose of 1, 10, or 100 g/100 kg seeds. Next, a pot is filled with soil and the onion seeds and weed seeds are sowed. This pot is placed in a greenhouse. When the onion grows 2 to 6 leaves, the surface of the soil and stem leaves of the weeds are uniformly treated with one or more crystals selected from the group consisting of 1^{st} crystal of flumioxazin to 7^{th} crystal of flumioxazin at a dose of 12.5, 25, 50, or 100 g/ha. The pest control effect and crop injuries are examined 15 days after the treatment with A-type crystal flumioxazin.

### Example 23

One or more compounds selected from the group B are attached to garlic bulbs at a dose of 1, 10, or 100/100 kg bulbs. Next, a pot is filled with soil, then weed seeds are sowed and the bulbs are planted. On the day of sowing and planting, the surface of the soil is uniformly treated with one or more crystals selected from the group consisting of 1^{st} crystal of flumioxazin to 7^{th} crystal of flumioxazin at a dose of 50, 100, 200, or 400 g/ha. This pot is placed in a greenhouse. The pest control effect and crop injuries are examined 15 days after sowing and planting.

### Example 24

One or more compounds selected from the group B are attached to sunflower seeds at a dose of 1, 10, or 100 g/100 kg seeds. Next, a pot is filled with soil and the sunflower seeds and weed seeds are sowed. This pot is placed in a greenhouse. When the sunflower grows 2 to 6 leaves, the surface of the soil and stem leaves of the weeds are uniformly treated with one or more crystals selected from the group consisting of 1^{st} crystal of flumioxazin to 7^{th} crystal of flumioxazin at a dose of 12.5, 25, 50, or 100 g/ha. The pest control effect and crop injuries are examined 15 days after the treatment with one or more crystals selected from the group consisting of 1^{st} crystal of flumioxazin to 7^{th} crystal of flumioxazin.

### Example 25

One or more compounds selected from the group B are attached to wheat seeds at a dose of 1, 10, or 100 g/100 kg seeds. Next, a pot is filled with soil and the wheat seeds and weed seeds are sowed. This pot is placed in a greenhouse. When the wheat grows 2 to 6 leaves, the surface of the soil and stem leaves of the weeds are uniformly treated with one or more crystals selected from the group consisting of 1^{st} crystal of flumioxazin to 7^{th} crystal of flumioxazin at a dose of 12.5, 25, 50, or 100 g/ha. The pest control effect and crop injuries are examined 15 days after the treatment with one or more crystals selected from the group consisting of 1^{st} crystal of flumioxazin to 7^{th} crystal of flumioxazin.

### Example 26

Each of combinations of compounds selected from the combinations shown in Tables 9, 10 and 11 is attached to soybean seeds, corn seeds, or cotton seeds at a dose of 1, 10, or 100 g/100 kg seeds. Next, a pot is filled with soil and the crop seeds and weed seeds are sowed. On the day of sowing, the surface of the soil is uniformly treated with one or more crystals selected from the group consisting of 1^{st} crystal of flumioxazin to 7^{th} crystal of flumioxazin at a dose of 25, 50, 100, 200, or 400 g/ha. This pot is placed in a greenhouse. The pest control effect and crop injuries are examined 15 days after the treatment with one or more crystals selected from the group consisting of 1^{st} crystal of flumioxazin to 7^{th} crystal of flumioxazin.

### Example 27

Each of combinations of compounds selected from the combinations shown in Tables 9, 10 and 11 is attached to cotton seeds at a dose of 1, 10, or 100 g/100 kg seeds. Next, a pot is filled with soil and the cotton seeds and weed seeds are sowed. The surface of the soil and stem leaves of the weeds are uniformly treated with one or more crystals selected from the group consisting of 1^{st} crystal of flumioxazin to 7^{th} crystal of flumioxazin at a dose of 25, 50, 100, 200, or 400 g/ha in the condition of the cotton main stem being lignified at a length of 15 cm from the surface of the ground 30 days after these seeds are sowed. This pot is placed in a greenhouse. The pest control effect and crop injuries are examined 15 days after the treatment with one or more crystals selected from the group consisting of 1^{st} crystal of flumioxazin to 7^{th} crystal of flumioxazin.

TABLE 9

| | |
|---|---|
| Number of | |
| combination | Combinations of compounds |

| | | |
|---|---|---|
| 1-1 | Clothianidin | Ipconazole |
| 1-2 | Clothianidin | Metconazole |
| 1-3 | Clothianidin | Diphenoconazole |
| 1-4 | Clothianidin | Tebuconazole |
| 1-5 | Clothianidin | Prothioconazole |
| 1-6 | Clothianidin | Fluquinconazole |
| 1-7 | Clothianidin | Triticonazole |
| 1-8 | Clothianidin | Imazalil |
| 1-9 | Clothianidin | Pencycuron |
| 1-10 | Clothianidin | Prochloraz |
| 1-11 | Clothianidin | Pyraclostrobin |
| 1-12 | Clothianidin | Azoxystrobin |
| 1-13 | Clothianidin | Trifloxystrobin |
| 1-14 | Clothianidin | Metalaxyl |
| 1-15 | Clothianidin | Metalaxyl-M |
| 1-16 | Clothianidin | Fludioxonil |
| 1-17 | Clothianidin | Thiram |
| 1-18 | Clothianidin | Mancozeb |
| 1-19 | Clothianidin | Flutolanil |
| 1-20 | Clothianidin | Sedaxane |
| 1-21 | Clothianidin | Penflufen |
| 1-22 | Clothianidin | Fluxapyroxad |
| 1-23 | Clothianidin | Bacillus firmus |
| 1-24 | Clothianidin | Pasteuria penetrans |
| 1-25 | Clothianidin | Abamectin |
| 1-26 | Clothianidin | Thiodicarb |
| 1-27 | Clothianidin | Tolclophos-methyl |
| 1-28 | Clothianidin | Ethaboxam |
| 1-29 | Clothianidin | Compound 4 |
| 1-30 | Clothianidin | Compound 2 |
| 1-31 | Clothianidin | Compound 3 |
| 1-32 | Clothianidin | Compound 1 |
| 1-33 | Clothianidin | Compound 5 |
| 1-34 | Clothianidin | Orysastrobin |
| 1-35 | Clothianidin | Isotianil |
| 1-36 | Clothianidin | Probenazole |
| 1-37 | Clothianidin | Diclocymet |
| 1-38 | Clothianidin | Furametpyr |
| 1-39 | Imidacloprid | Ipconazole |
| 1-40 | Imidacloprid | Metconazole |
| 1-41 | Imidacloprid | Diphenoconazole |
| 1-42 | Imidacloprid | Tebuconazole |
| 1-43 | Imidacloprid | Prothioconazole |
| 1-44 | Imidacloprid | Fluquinconazole |
| 1-45 | Imidacloprid | Triticonazole |
| 1-46 | Imidacloprid | Imazalil |
| 1-47 | Imidacloprid | Pencycuron |
| 1-48 | Imidacloprid | Prochloraz |
| 1-49 | Imidacloprid | Pyraclostrobin |
| 1-50 | Imidacloprid | Azoxystrobin |
| 1-51 | Imidacloprid | Trifloxystrobin |
| 1-52 | Imidacloprid | Metalaxyl |
| 1-53 | Imidacloprid | Metalaxyl-M |
| 1-54 | Imidacloprid | Fludioxonil |
| 1-55 | Imidacloprid | Thiram |
| 1-56 | Imidacloprid | Mancozeb |
| 1-57 | Imidacloprid | Flutolanil |
| 1-58 | Imidacloprid | Sedaxane |
| 1-59 | Imidacloprid | Penflufen |
| 1-60 | Imidacloprid | Fluxapyroxad |
| 1-61 | Imidacloprid | Bacillus firmus |
| 1-62 | Imidacloprid | Pasteuria penetrans |
| 1-63 | Imidacloprid | Abamectin |
| 1-64 | Imidacloprid | Thiodicarb |
| 1-65 | Imidacloprid | Tolclophos-methyl |
| 1-66 | Imidacloprid | Ethaboxam |
| 1-67 | Imidacloprid | Compound 4 |
| 1-68 | Imidacloprid | Compound 2 |
| 1-69 | Imidacloprid | Compound 3 |
| 1-70 | Imidacloprid | Compound 1 |
| 1-71 | Imidacloprid | Compound 5 |
| 1-72 | Imidacloprid | Orysastrobin |
| 1-73 | Imidacloprid | Isotianil |
| 1-74 | Imidacloprid | Probenazole |
| 1-75 | Imidacloprid | Diclocymet |
| 1-76 | Imidacloprid | Furametpyr |
| 1-77 | Thiamethoxam | Ipconazole |
| 1-78 | Thiamethoxam | Metconazole |
| 1-79 | Thiamethoxam | Diphenoconazole |
| 1-80 | Thiamethoxam | Tebuconazole |
| 1-81 | Thiamethoxam | Prothioconazole |
| 1-82 | Thiamethoxam | Fluquinconazole |
| 1-83 | Thiamethoxam | Triticonazole |
| 1-84 | Thiamethoxam | Imazalil |
| 1-85 | Thiamethoxam | Pencycuron |
| 1-86 | Thiamethoxam | Prochloraz |
| 1-87 | Thiamethoxam | Pyraclostrobin |
| 1-88 | Thiamethoxam | Azoxystrobin |
| 1-89 | Thiamethoxam | Trifloxystrobin |
| 1-90 | Thiamethoxam | Metalaxyl |
| 1-91 | Thiamethoxam | Metalaxyl-M |
| 1-92 | Thiamethoxam | Fludioxonil |
| 1-93 | Thiamethoxam | Thiram |
| 1-94 | Thiamethoxam | Mancozeb |
| 1-95 | Thiamethoxam | Flutolanil |
| 1-96 | Thiamethoxam | Sedaxane |
| 1-97 | Thiamethoxam | Penflufen |
| 1-98 | Thiamethoxam | Fluxapyroxad |
| 1-99 | Thiamethoxam | Bacillus firmus |
| 1-100 | Thiamethoxam | Pasteuria penetrans |
| 1-101 | Thiamethoxam | Abamectin |
| 1-102 | Thiamethoxam | Thiodicarb |
| 1-103 | Thiamethoxam | Tolclophos-methyl |
| 1-104 | Thiamethoxam | Ethaboxam |
| 1-105 | Thiamethoxam | Compound 4 |
| 1-106 | Thiamethoxam | Compound 2 |
| 1-107 | Thiamethoxam | Compound 3 |
| 1-108 | Thiamethoxam | Compound 1 |
| 1-109 | Thiamethoxam | Compound 5 |
| 1-110 | Thiamethoxam | Orysastrobin |
| 1-111 | Thiamethoxam | Isotianil |
| 1-112 | Thiamethoxam | Probenazole |
| 1-113 | Thiamethoxam | Diclocymet |
| 1-114 | Thiamethoxam | Furametpyr |
| 1-115 | Beta-cyfluthrin | Ipconazole |
| 1-116 | Beta-cyfluthrin | Metconazole |
| 1-117 | Beta-cyfluthrin | Diphenoconazole |
| 1-118 | Beta-cyfluthrin | Tebuconazole |
| 1-119 | Beta-cyfluthrin | Prothioconazole |
| 1-120 | Beta-cyfluthrin | Fluquinconazole |
| 1-121 | Beta-cyfluthrin | Triticonazole |
| 1-122 | Beta-cyfluthrin | Imazalil |
| 1-123 | Beta-cyfluthrin | Pencycuron |
| 1-124 | Beta-cyfluthrin | Prochloraz |
| 1-125 | Beta-cyfluthrin | Pyraclostrobin |
| 1-126 | Beta-cyfluthrin | Azoxystrobin |
| 1-127 | Beta-cyfluthrin | Trifloxystrobin |
| 1-128 | Beta-cyfluthrin | Metalaxyl |
| 1-129 | Beta-cyfluthrin | Metalaxyl-M |
| 1-130 | Beta-cyfluthrin | Fludioxonil |
| 1-131 | Beta-cyfluthrin | Thiram |
| 1-132 | Beta-cyfluthrin | Mancozeb |
| 1-133 | Beta-cyfluthrin | Flutolanil |
| 1-134 | Beta-cyfluthrin | Sedaxane |
| 1-135 | Beta-cyfluthrin | Penflufen |
| 1-136 | Beta-cyfluthrin | Fluxapyroxad |
| 1-137 | Beta-cyfluthrin | Bacillus firmus |
| 1-138 | Beta-cyfluthrin | Pasteuria penetrans |
| 1-139 | Beta-cyfluthrin | Abamectin |
| 1-140 | Beta-cyfluthrin | Thiodicarb |
| 1-141 | Beta-cyfluthrin | Tolclophos-methyl |
| 1-142 | Beta-cyfluthrin | Ethaboxam |
| 1-143 | Beta-cyfluthrin | Compound 4 |
| 1-144 | Beta-cyfluthrin | Compound 2 |
| 1-145 | Beta-cyfluthrin | Compound 3 |
| 1-146 | Beta-cyfluthrin | Compound 1 |
| 1-147 | Beta-cyfluthrin | Compound 5 |
| 1-148 | Abamectin | Ipconazole |
| 1-149 | Abamectin | Metconazole |
| 1-150 | Abamectin | Diphenoconazole |
| 1-151 | Abamectin | Tebuconazole |
| 1-152 | Abamectin | Prothioconazole |
| 1-153 | Abamectin | Fluquinconazole |
| 1-154 | Abamectin | Triticonazole |
| 1-155 | Abamectin | Imazalil |
| 1-156 | Abamectin | Pencycuron |
| 1-157 | Abamectin | Prochloraz |
| 1-158 | Abamectin | Pyraclostrobin |
| 1-159 | Abamectin | Azoxystrobin |
| 1-160 | Abamectin | Trifloxystrobin |
| 1-161 | Abamectin | Metalaxyl |
| 1-162 | Abamectin | Metalaxyl-M |
| 1-163 | Abamectin | Fludioxonil |
| 1-164 | Abamectin | Thiram |
| 1-165 | Abamectin | Mancozeb |
| 1-166 | Abamectin | Flutolanil |
| 1-167 | Abamectin | Sedaxane |
| 1-168 | Abamectin | Penflufen |
| 1-169 | Abamectin | Fluxapyroxad |
| 1-170 | Abamectin | Bacillus firmus |
| 1-171 | Abamectin | Pasteuria penetrans |
| 1-172 | Abamectin | Thiodicarb |
| 1-173 | Abamectin | Tolclophos-methyl |
| 1-174 | Abamectin | Ethaboxam |
| 1-175 | Abamectin | Compound 4 |
| 1-176 | Abamectin | Compound 2 |
| 1-177 | Abamectin | Compound 3 |
| 1-178 | Abamectin | Compound 1 |
| 1-179 | Abamectin | Compound 5 |
| 1-180 | Thiodicarb | Ipconazole |
| 1-181 | Thiodicarb | Metconazole |
| 1-182 | Thiodicarb | Diphenoconazole |
| 1-183 | Thiodicarb | Tebuconazole |
| 1-184 | Thiodicarb | Prothioconazole |
| 1-185 | Thiodicarb | Fluquinconazole |
| 1-186 | Thiodicarb | Triticonazole |
| 1-187 | Thiodicarb | Imazalil |
| 1-188 | Thiodicarb | Pencycuron |
| 1-189 | Thiodicarb | Prochloraz |
| 1-190 | Thiodicarb | Pyraclostrobin |
| 1-191 | Thiodicarb | Azoxystrobin |
| 1-192 | Thiodicarb | Trifloxystrobin |
| 1-193 | Thiodicarb | Metalaxyl |
| 1-194 | Thiodicarb | Metalaxyl-M |
| 1-195 | Thiodicarb | Fludioxonil |
| 1-196 | Thiodicarb | Thiram |
| 1-197 | Thiodicarb | Mancozeb |
| 1-198 | Thiodicarb | Flutolanil |
| 1-199 | Thiodicarb | Sedaxane |
| 1-200 | Thiodicarb | Penflufen |
| 1-201 | Thiodicarb | Fluxapyroxad |
| 1-202 | Thiodicarb | Bacillus firmus |
| 1-203 | Thiodicarb | Pasteuria penetrans |
| 1-204 | Thiodicarb | Tolclophos-methyl |
| 1-205 | Thiodicarb | Ethaboxam |
| 1-206 | Thiodicarb | Compound 4 |
| 1-207 | Thiodicarb | Compound 2 |
| 1-208 | Thiodicarb | Compound 3 |
| 1-209 | Thiodicarb | Compound 1 |
| 1-210 | Thiodicarb | Compound 5 |
| 1-211 | Thiodicarb | Furametpyr |
| 1-212 | Metalaxyl | Ipconazole |
| 1-213 | Metalaxyl | Metconazole |
| 1-214 | Metalaxyl | Diphenoconazole |
| 1-215 | Metalaxyl | Tebuconazole |
| 1-216 | Metalaxyl | Prothioconazole |
| 1-217 | Metalaxyl | Fluquinconazole |
| 1-218 | Metalaxyl | Triticonazole |
| 1-219 | Metalaxyl | Imazalil |
| 1-220 | Metalaxyl | Pencycuron |
| 1-221 | Metalaxyl | Prochloraz |
| 1-222 | Metalaxyl | Pyraclostrobin |
| 1-223 | Metalaxyl | Azoxystrobin |
| 1-224 | Metalaxyl | Trifloxystrobin |
| 1-225 | Metalaxyl | Fludioxonil |
| 1-226 | Metalaxyl | Thiram |
| 1-227 | Metalaxyl | Flutolanil |
| 1-228 | Metalaxyl | Sedaxane |
| 1-229 | Metalaxyl | Penflufen |
| 1-230 | Metalaxyl | Fluxapyroxad |
| 1-231 | Metalaxyl | Bacillus firmus |
| 1-232 | Metalaxyl | Pasteuria penetrans |
| 1-233 | Metalaxyl | Tolclophos-methyl |
| 1-234 | Metalaxyl | Ethaboxam |
| 1-235 | Metalaxyl | Compound 4 |
| 1-236 | Metalaxyl | Compound 2 |
| 1-237 | Metalaxyl | Compound 3 |
| 1-238 | Metalaxyl | Compound 1 |
| 1-239 | Metalaxyl | Compound 5 |
| 1-240 | Metalaxyl | Furametpyr |
| 1-241 | Metalaxyl-M | Ipconazole |
| 1-242 | Metalaxvl-M | Metconazole |
| 1-243 | Metalaxyl-M | Diphenoconazole |
| 1-244 | Metalaxyl-M | Tebuconazole |
| 1-245 | Metalaxyl-M | Prothioconazole |
| 1-246 | Meta axyl-M | Fluquinconazole |
| 1-247 | Metalaxyl-M | Triticonazole |
| 1-248 | Metalaxyl-M | Imazalil |
| 1-249 | Metalaxyl-M | Pencycuron |
| 1-250 | Metalaxyl-M | Prochloraz |
| 1-251 | Metalaxyl-M | Pyraclostrobin |
| 1-252 | Metalaxyl-M | Azoxystrobin |
| 1-253 | Metalaxyl-M | Trifloxystrobin |
| 1-254 | Metalaxyl-M | Fludioxonil |
| 1-255 | Metalaxyl-M | Thiram |
| 1-256 | Metalaxyl-M | Flutolanil |
| 1-257 | Metalaxyl-M | Sedaxane |
| 1-258 | Metalaxyl-M | Penflufen |
| 1-259 | Metalaxyl-M | Fluxapyroxad |
| 1-260 | Metalaxyl-M | Bacillus firmus |
| 1-261 | Metalaxyl-M | Pasteuria penetrans |
| 1-262 | Metalaxyl-M | Tolclophos-methyl |
| 1-263 | Metalaxyl-M | Ethaboxam |
| 1-264 | Metalaxyl-M | Compound 4 |
| 1-265 | Metalaxyl-M | Compound 2 |
| 1-266 | Metalaxyl-M | Compound 3 |
| 1-267 | Metalaxyl-M | Compound 1 |
| 1-268 | Metalaxyl-M | Compound 5 |
| 1-269 | Metalaxyl-M | Furametpyr |
| 1-270 | Fludioxonil | Ipconazole |
| 1-271 | Fludioxonil | Metconazole |
| 1-272 | Fludioxonil | Diphenoconazole |
| 1-273 | Fludioxonil | Tebuconazole |
| 1-274 | Fludioxonil | Prothioconazole |
| 1-275 | Fludioxonil | Fluquinconazole |
| 1-276 | Fludioxonil | Triticonazole |
| 1-277 | Fludioxonil | Imazalil |
| 1-278 | Fludioxonil | Pencycuron |
| 1-279 | Fludioxonil | Prochloraz |
| 1-280 | Fludioxonil | Pyraclostrobin |
| 1-281 | Fludioxonil | Azoxystrobin |
| 1-282 | Fludioxonil | Trifloxystrobin |
| 1-283 | Fludioxonil | Thiram |
| 1-284 | Fludioxonil | Flutolanil |
| 1-285 | Fludioxonil | Sedaxane |
| 1-286 | Fludioxonil | Penflufen |
| 1-287 | Fludioxonil | Fluxapyroxad |
| 1-288 | Fludioxonil | Bacillus firmus |
| 1-289 | Fludioxonil | Pasteuria penetrans |
| 1-290 | Fludioxonil | Tolclophos-methyl |
| 1-291 | Fludioxonil | Ethaboxam |
| 1-292 | Fludioxonil | Compound 4 |
| 1-293 | Fludioxonil | Compound 2 |
| 1-294 | Fludioxonil | Compound 3 |
| 1-295 | Fludioxonil | Compound 1 |
| 1-296 | Fludioxonil | Compound 5 |
| 1-297 | Fludioxonil | Furametpyr |
| 1-299 | Ipconazole | Pyraclostrobin |
| 1-299 | Ipconazole | Azoxystrobin |
| 1-300 | Ipconazole | Trifloxystrobin |
| 1-301 | Ipconazole | Thiram |
| 1-302 | Ipconazole | Flutolanil |
| 1-303 | Ipconazole | Sedaxane |
| 1-304 | Ipconazole | Penflufen |
| 1-305 | Ipconazole | Fluxapyroxad |
| 1-306 | Ipconazole | Bacillus firmus |
| 1-307 | Ipconazole | Pasteuria penetrans |
| 1-308 | Ipconazole | Tolclophos-methyl |
| 1-309 | Ipconazole | Ethaboxam |
| 1-310 | Ipconazole | Compound 4 |
| 1-311 | Ipconazole | Compound 2 |
| 1-312 | Ipconazole | Compound 3 |
| 1-313 | Ipconazole | Compound 1 |
| 1-314 | Ipconazole | Compound 5 |
| 1-315 | Metconazole | Pyraclostrobin |
| 1-316 | Metconazole | Azoxystrobin |
| 1-317 | Metconazole | Trifloxystrobin |
| 1-318 | Metconazole | Thiram |
| 1-319 | Metconazole | Flutolanil |
| 1-320 | Metconazole | Sedaxane |
| 1-321 | Metconazole | Penflufen |
| 1-322 | Metconazole | Fluxapyroxad |
| 1-323 | Metconazole | Bacillus firmus |
| 1-324 | Metconazole | Pasteuria penetrans |
| 1-325 | Metconazole | Tolclophos-methyl |
| 1-326 | Metconazole | Ethaboxam |
| 1-327 | Metconazole | Compound 4 |
| 1-328 | Metconazole | Compound 2 |
| 1-329 | Metconazole | Compound 3 |
| 1-330 | Metconazole | Compound 1 |
| 1-331 | Metconazole | Compound 5 |
| 1-332 | Diphenoconazole | Pyraclostrobin |
| 1-333 | Diphenoconazole | Azoxystrobin |
| 1-334 | Diphenoconazole | Trifloxystrobin |
| 1-335 | Diphenoconazole | Thiram |
| 1-336 | Diphenoconazole | Flutolanil |
| 1-337 | Diphenoconazole | Sedaxane |
| 1-338 | Diphenoconazole | Penflufen |
| 1-339 | Diphenoconazole | Fluxapyroxad |
| 1-340 | Diphenoconazole | Bacillus firmus |
| 1-341 | Diphenoconazole | Pasteuria penetrans |
| 1-342 | Diphenoconazole | Tolclophos-methyl |
| 1-343 | Diphenoconazole | Ethaboxam |
| 1-344 | Diphenoconazole | Compound 4 |
| 1-345 | Diphenoconazole | Compound 2 |
| 1-346 | Diphenoconazole | Compound 3 |
| 1-347 | Diphenoconazole | Compound 1 |
| 1-348 | Diphenoconazole | Compound 5 |
| 1-349 | Prothioconazole | Pyraclostrobin |
| 1-350 | Prothioconazole | Azoxystrobin |
| 1-351 | Prothioconazole | Trifloxystrobin |
| 1-352 | Prothioconazole | Thiram |
| 1-353 | Prothioconazole | Flutolanil |
| 1-354 | Prothioconazole | Sedaxane |
| 1-355 | Prothioconazole | Penflufen |
| 1-356 | Prothioconazole | Fluxapyroxad |
| 1-357 | Prothioconazole | Bacillus firmus |
| 1-358 | Prothioconazole | Pasteuria penetrans |
| 1-359 | Prothioconazole | Tolclophos-methyl |
| 1-360 | Prothioconazole | Ethaboxam |
| 1-361 | Prothioconazole | Compound 4 |
| 1-362 | Prothioconazole | Compound 2 |
| 1-363 | Prothioconazole | Compound 3 |
| 1-364 | Prothioconazole | Compound 1 |
| 1-365 | Prothioconazole | Compound 5 |
| 1-366 | Fipronil | Tefluthrin |
| 1-367 | Imidacloprid | Tefluthrin |
| 1-368 | Carboxin | Thiram |
| 1-369 | Pyraclostrobin | Fluxapyroxad |
| 1-370 | Flutolanil | Mancozeh |
| 1-371 | Fluquinconazole | Prochloraz |

TABLE 10

| | |
|---|---|
| Number of | |
| combination | Combinations of compounds |

| | | |
|---|---|---|
| 2-1 | Combination of 1-14 | Pyraclostrobin |
| 2-2 | Combination of 1-14 | Azoxystrobin |
| 2-3 | Combination of 1-14 | Trifloxystrobin |
| 2-4 | Combination of 1-14 | Compound 1 |
| 2-5 | Combination of 1-14 | Metconazole |
| 2-6 | Combination of 1-14 | Prothioconazole |
| 2-7 | Combination of 1-14 | Triticonazole |
| 2-8 | Combination of 1-14 | Tebuconazole |
| 2-9 | Combination of 1-14 | Diphenoconazole |
| 2-10 | Combination of 1-14 | Ipconazole |
| 2-11 | Combination of 1-14 | Thlophanate-methyl |
| 2-12 | Combination of 1-14 | Fludioxonil |
| 2-13 | Combination of 1-14 | Tolclophos-methyl |
| 2-14 | Combination of 1-14 | Thiram |
| 2-15 | Combination of 1-14 | Captan |
| 2-16 | Combination of 1-14 | Carboxin |
| 2-17 | Combination of 1-14 | Boscalid |
| 2-18 | Combination of 1-14 | Thiabendazole |
| 2-19 | Combination of 1-14 | Ethaboxam |
| 2-20 | Combination of 1-15 | Pyraclostrobin |
| 2-21 | Combination of 1-15 | Azoxystrobin |
| 2-22 | Combination of 1-15 | Trifloxystrobin |
| 2-23 | Combination of 1-15 | Compound 1 |
| 2-24 | Combination of 1-15 | Metconazole |
| 2-25 | Combination of 1-15 | Prothioconazole |
| 2-26 | Combination of 1-15 | Triticonazole |
| 2-27 | Combination of 1-15 | Tebuconazole |
| 2-28 | Combination of 1-15 | Diphenoconazole |
| 2-29 | Combination of 1-15 | Ipconazole |
| 2-30 | Combination of 1-15 | Thiophanate-methyl |
| 2-31 | Combination of 1-15 | Fludioxonil |
| 2-32 | Combination of 1-15 | Tolclophos-methyl |
| 2-33 | Combination of 1-15 | Thiran |
| 2-34 | Combination of 1-15 | Captan |
| 2-35 | Combination of 1-15 | Carboxin |
| 2-36 | Combination of 1-15 | Boscalid |
| 2-37 | Combination of 1-15 | Thiabendazole |
| 2-38 | Combination of 1-15 | Ethaboxam |
| 2-39 | Combination of 1-18 | Pyraclostrobin |
| 2-40 | Combination of 1-18 | Azoxystrobin |
| 2-41 | Combination of 1-18 | Trifloxystrobin |
| 2-42 | Combination of 1-18 | Compound 1 |
| 2-43 | Combination of 1-18 | Metconazole |
| 2-44 | Combination of 1-18 | Prothioconazole |
| 2-45 | Combination of 1-18 | Triticonazole |
| 2-46 | Combination of 1-18 | Tebuconazole |
| 2-47 | Combination of 1-18 | Diphenoconazole |
| 2-48 | Combination of 1-18 | Ipconazole |
| 2-49 | Combination of 1-18 | Thiophanate-methyl |
| 2-50 | Combination of 1-18 | Fludioxonil |
| 2-51 | Combination of 1-18 | Tolclophos-methyl |
| 2-52 | Combination of 1-13 | Thiram |
| 2-53 | Combination of 1-18 | Captan |
| 2-54 | Combination of 1-18 | Carboxin |
| 2-55 | Combination of 1-18 | Boscalid |
| 2-56 | Combination of 1-18 | Thiabendazole |
| 2-57 | Combination of 1-28 | Boscalid |
| 2-58 | Combination of 1-28 | Metconazole |
| 2-59 | Combination of 1-28 | Ipconazole |
| 2-60 | Combination of 1-28 | Triticonazole |
| 2-61 | Combination of 1-28 | Tebuconazole |
| 2-62 | Combination of 1-28 | Thiabendazole |
| 2-63 | Combination of 1-28 | Carboxin |
| 2-64 | Combination of 1-28 | Penflufen |
| 2-65 | Combination of 1-28 | Sedaxane |
| 2-66 | Combination of 1-28 | Fluxapyroxad |
| 2-67 | Combination of 1-28 | Fluopyram |
| 2-68 | Combination of 1-28 | Thiram |
| 2-69 | Combination of 1-233 | Metconazole |
| 2-70 | Combination of 1-27 | Ipconazole |
| 2-71 | Combination of 1-14 | Compound 5 |
| 2-72 | Combination of 1-15 | Compound 5 |
| 2-73 | Combination of 1-28 | Compound 5 |
| 2-74 | Combination of 1-90 | Fludioxonil |
| 2-75 | Combination of 1-91 | Fludioxonil |
| 2-76 | Combination of 1-52 | Pyraclostrobin |
| 2-77 | Combination of 1-53 | Pyraclostrobin |
| 2-78 | Combination of 1-52 | Trifloxystrobin |
| 2-79 | Combination of 1-53 | Trifloxystrobin |
| 2-80 | Combination of 1-216 | Penflufen |
| 2-81 | Combination of 1-4 | Bacillus firmus |
| 2-82 | Combination of 1-52 | Tebuconazole |
| 2-83 | Combination of 1-53 | Tebuconazole |
| 2-84 | Combination of 1-42 | Triazoxide |
| 2-85 | Combination of 1-52 | Mycrobutanil |
| 2-86 | Combination of 1-53 | Mycrobutanil |

TABLE 11

| Number | | | | |
|---|---|---|---|---|
| of | | | | |
| combination | Combination of compounds | | | |
| 3-1 | Combination of 2-57 | Pyraclostrobin | Compound 1 | |
| 3-2 | Combination of 2-57 | Pyraclostrobin | Tolclophos-methyl | |
| 3-3 | Combination of 2-57 | Pyraclostrobin | Metconazole | |
| 3-4 | Combination of 2-57 | Pyraclostrobin | Metalaxyl | |
| 3-5 | Combination of 2-17 | Pyraclostrobin | Metconazole | |
| 3-6 | Combination of 2-36 | Pyraclostrobin | Metconazole | |
| 3-7 | Combination of 2-17 | Pyraclostrobin | Compound 1 | |
| 3-8 | Combination of 2-36 | Pyraclostrobin | Compound 1 | |
| 3-9 | Combination of 2-17 | Pyraclostrobin | Tolclophos-methyl | |
| 3-10 | Combination of 2-36 | Pyraclostrobin | Tolclophos-methyl | |
| 3-11 | Combination of 2-10 | Thiram | | |
| 3-12 | Combination of 2-14 | Trifloxystrobin | | |
| 3-13 | Combination of 2-33 | Trifloxystrobin | | |
| 3-14 | Combination of 2-24 | Trifloxystrobin | | |
| 3-15 | Combination of 2-22 | Compound 1 | | |
| 3-16 | Combination of 2-23 | Azoxystrobin | | |
| 3-17 | Combination of 2-23 | Thiabendazole | | |
| 3-18 | Combination of 2-32 | Trifloxystrobin | | |
| 3-19 | Combination of 2-32 | Azoxystrobin | | |
| 3-20 | Combination of 2-32 | Thiabendazole | | |
| 3-21 | Combination of 2-19 | Trifloxystrobin | Compound 1 | |
| 3-22 | Combination of 2-19 | Azoxystrobin | Compound 1 | |
| 3-23 | Combination of 2-29 | Thiram | Compound 1 | |
| 3-24 | Combination of 2-29 | Tolclophos-methyl | | |
| 3-25 | Combination of 2-5 | Ethaboxam | Compound 1 | |
| 3-26 | Combination of 2-58 | Compound 1 | | |
| 3-27 | Combination of 2-58 | Diphenoconazole | | |
| 3-28 | Combination of 2-5 | Diphenoconazole | | |
| 3-29 | Combination of 2-24 | Diphenoconazole | | |
| 3-30 | Combination of 2-59 | Diphenoconazole | | |
| 3-31 | Combination of 2-60 | Diphenoconazole | | |
| 3-32 | Combination of 2-61 | Diphenoconazole | | |
| 3-33 | Combination of 2-62 | Diphenoconazole | | |
| 3-34 | Combination of 2-63 | Diphenoconazole | | |
| 3-35 | Combination of 2-64 | Diphenoconazole | | |
| 3-36 | Combination of 2-65 | Diphenoconazole | | |
| 3-37 | Combination of 2-66 | Diphenoconazole | | |
| 3-38 | Combination of 2-67 | Diphenoconazole | | |
| 3-39 | Combination of 2-68 | Diphenoconazole | | |
| 3-40 | Combination of 2-19 | Metconazole | Diphenoconazole | |
| 3-41 | Combination of 2-19 | Ipconazole | Diphenoconazole | |
| 3-42 | Combination of 2-19 | Triticonazole | Diphenoconazole | |
| 3-43 | Combination of 2-19 | Tebuconazole | Diphenoconazole | |
| 3-44 | Combination of 2-19 | Thiabendazole | Diphenoconazole | |
| 3-45 | Combination of 2-19 | Carboxin | Diphenoconazole | |
| 3-46 | Combination of 2-19 | Penflufen | Diphenoconazole | |
| 3-47 | Combination of 2-19 | Sedaxane | Diphenoconazole | |
| 3-48 | Combination of 2-19 | Fluxapyroxad | Diphenoconazole | |
| 3-49 | Combination of 2-19 | Fluopyram | Diphenoconazole | |
| 3-50 | Combination of 2-19 | Thiram | Diphenoconazole | |
| 3-51 | Combination of 2-17 | Pyraclostrobin | Ipconazole | |
| 3-52 | Combination of 2-36 | Pyraclostrobin | Ipconazole | |
| 3-53 | Combination of 2-57 | Pyraclostrobin | Ipconazole | |
| 3-54 | Combination of 2-10 | Trifloxystrobin | | |
| 3-55 | Combination of 2-29 | Trifloxystrobin | | |
| 3-56 | Combination of 2-59 | Trifloxystrobin | | |
| 3-57 | Combination of 2-19 | Ipconazole | Trifloxystrobin | |
| 3-58 | Combination of 2-29 | Azoxystrobin | | |
| 3-59 | Combination of 2-59 | Azoxystrobin | | |
| 3-60 | Combination of 2-19 | Ipconazole | Azoxystrobin | |
| 3-61 | Combination of 2-5 | Compound 1 | Carboxin | |
| 3-62 | Combination of 2-5 | Compound 1 | Penflufen | |
| 3-63 | Combination of 2-5 | Compound 1 | Sedaxane | |
| 3-64 | Combination of 2-5 | Compound 1 | Fluxapyroxad | |
| 3-65 | Combination of 2-5 | Compound 1 | Fluopyram | |
| 3-66 | Combination of 2-5 | Compound 1 | Oxycarboxin | |
| 3-67 | Combination of 2-5 | Compound 1 | Thifluzamide | |
| 3-68 | Combination of 2-5 | Compound 1 | Flutolanil | |
| 3-69 | Combination of 2-5 | Compound 1 | Pencycuron | |
| 3-70 | Combination of 2-5 | Compound 1 | Fludioxonil | |
| 3-71 | Combination of 2-32 | Compound 1 | Metconazole | |
| 3-72 | Combination of 2-32 | Compound 1 | Tebuconazole | |
| 3-73 | Combination of 2-32 | Compound 1 | Diphenoconazole | |
| 3-74 | Combination of 2-32 | Compound 1 | Triticonazole | |
| 3-75 | Combination of 2-32 | Compound 1 | Imazalil | |
| 3-76 | Combination of 2-32 | Compound 1 | Triadimenol | |
| 3-77 | Combination of 2-32 | Compound 1 | Fluquinconazole | |
| 3-78 | Combination of 2-32 | Compound 1 | Prochloraz | |
| 3-79 | Combination of 2-32 | Compound 1 | Prothioconazole | |
| 3-80 | Combination of 2-32 | Compound 1 | Diniconazole | |
| 3-81 | Combination of 2-32 | Compound 1 | Diniconazole-M | |
| 3-82 | Combination of 2-32 | Compound 1 | Ipconazole | |
| 3-83 | Combination of 2-32 | Compound 1 | Cyproconazole | |
| 3-84 | Combination of 2-32 | Compound 1 | Tetraconazole | |
| 3-85 | Combination of 2-32 | Compound 1 | Carboxin | |
| 3-86 | Combination of 2-32 | Compound 1 | Penflufen | |
| 3-87 | Combination of 2-32 | Compound 1 | Sedaxane | |
| 3-88 | Combination of 2-32 | Compound 1 | Fluxapyroxad | |
| 3-89 | Combination of 2-32 | Compound 1 | Fluopyrm | |
| 3-90 | Combination of 2-32 | Compound 1 | Oxycarboxin | |
| 3-91 | Combination of 2-32 | Compound 1 | Fludioxonil | |
| 3-92 | Combination of 2-32 | Compound 1 | Thiram | |
| 3-93 | Combination of 2-32 | Compound 1 | Captan | |
| 3-94 | Combination of 2-32 | Compound 1 | Thiophanate-methyl | |
| 3-95 | Combination of 2-32 | Compound 1 | Thiabendazole | |
| 3-96 | Combination of 2-13 | Compound 1 | Metconazole | |
| 3-97 | Combination of 2-13 | Compound 1 | Tebuconazole | |
| 3-98 | Combination of 2-13 | Compound 1 | Diphenoconazole | |
| 3-99 | Combination of 2-13 | Compound 1 | Triticonazole | |
| 3-100 | Combination of 2-13 | Compound 1 | Imazalil | |
| 3-101 | Combination of 2-13 | Compound 1 | Triadimenol | |
| 3-102 | Combination of 2-13 | Compound 1 | Fluquinconazole | |
| 3-103 | Combination of 2-13 | Compound 1 | Prochloraz | |
| 3-104 | Combination of 2-13 | Compound 1 | Prothioconazole | |
| 3-105 | Combination of 2-13 | Compound 1 | Diniconazole | |
| 3-106 | Combination of 2-13 | Compound 1 | Diniconazole-M | |
| 3-107 | Combination of 2-13 | Compound 1 | Ipconazole | |
| 3-108 | Combination of 2-13 | Compound 1 | Cyproconazole | |
| 3-109 | Combination of 2-13 | Compound 1 | Tetraconazole | |
| 3-110 | Combination of 2-13 | Compound 1 | Carboxin | |
| 3-111 | Combination of 2-13 | Compound 1 | Penflufen | |
| 3-112 | Combination of 2-13 | Compound 1 | Sedaxane | |
| 3-113 | Combination of 2-13 | Compound 1 | Fluxapyroxad | |
| 3-114 | Combination of 2-13 | Compound 1 | Fluopyram | |
| 3-115 | Combination of 2-13 | Compound 1 | Oxycarboxin | |
| 3-116 | Combination of 2-13 | Compound 1 | Fludioxonil | |
| 3-117 | Combination of 2-13 | Compound 1 | Thiram | |
| 3-118 | Combination of 2-13 | Compound 1 | Captan | |
| 3-119 | Combination of 2-13 | Compound 1 | Thiophanate-methyl | |
| 3-120 | Combination of 2-13 | Compound 1 | Thiabendazole | |
| 3-121 | Combination of 2-69 | Compound 1 | Oxadixyl | |
| 3-122 | Combination of 2-69 | Compound 1 | Hymexazol | |
| 3-123 | Combination of 2-69 | Compound 1 | Fenamidone | |
| 3-124 | Combination of 2-69 | Compound 1 | Cymoxanil | |
| 3-125 | Combination of 2-69 | Compound 1 | Fluopicolide | |
| 3-126 | Combination of 2-70 | Carboxin | | |
| 3-127 | Combination of 2-10 | Tolclophos-methyl | Carboxin | |
| 3-128 | Combination of 2-10 | Tolclophos-methyl | Penflufen | |
| 3-129 | Combination of 2-10 | Tolclophos-methyl | Sedaxane | |
| 3-130 | Combination of 2-10 | Tolclophos-methyl | Fluxapyroxad | |
| 3-131 | Combination of 2-10 | Tolclophos-methyl | Fluopyram | |
| 3-132 | Combination of 2-5 | Tolclophos-methyl | | |
| 3-133 | Combination of 2-5 | Tolclophos-methyl | Azoxystrobin | |
| 3-134 | Combination of 2-5 | Tolclophos-methyl | Fluoxastrobin | |
| 3-135 | Combination of 2-5 | Tolclophos-methyl | Trifloxystrobin | |
| 3-136 | Combination of 2-5 | Tolclophos-methyl | Pyraclostrobin | |
| 3-137 | Combination of 2-5 | Tolclophos-methyl | Orysastrobin | |
| 3-138 | Combination of 2-5 | Tolclophos-methyl | Carboxin | |
| 3-139 | Combination of 2-5 | Tolclophos-methyl | Oxycarboxin | |
| 3-140 | Combination of 2-5 | Tolclophos-methyl | Fludioxonil | |
| 3-141 | Combination of 2-5 | Tolclophos-methyl | Thiram | |
| 3-142 | Combination of 2-5 | Tolclophos-methyl | Captan | |
| 3-143 | Combination of 2-5 | Tolclophos-methyl | Thiophanate-methyl | |
| 3-144 | Combination of 2-5 | Tolclophos-methyl | Thiabendazole | |
| 3-145 | Combination of 2-5 | Ethaboxam | | |
| 3-146 | Combination of 2-5 | Ethaboxam | Tolclophos-methyl | |
| 3-147 | Combination of 2-38 | Compound 1 | Compound 2 | |
| 3-148 | Combination of 2-19 | Compound 1 | Compound 2 | |
| 3-149 | Combination of 2-19 | Compound 5 | Compound 2 | |
| 3-150 | Combination of 2-38 | Compound 5 | Compound 2 | |
| 3-151 | Combination of 2-19 | Ipconazole | Compound 3 | |
| 3-152 | Combination of 2-38 | Ipconazole | Compound 3 | |
| 3-153 | Combination of 2-19 | Metconazole | Compound 3 | |
| 3-154 | Combination of 2-38 | Metconazole | Compound 3 | |
| 3-155 | Combination of 2-19 | Tolclophos-methyl | Compound 3 | |
| 3-156 | Combination of 2-38 | Tolclophos-methyl | Compound 3 | |
| 3-157 | Combination of 2-19 | Compound 1 | Compound 3 | |
| 3-158 | Combination of 2-38 | Compound 1 | Compound 3 | |
| 3-159 | Combination of 2-19 | Compound 1 | Compound 3 | |
| 3-160 | Combination of 2-38 | Compound 1 | Compound 3 | |
| 3-161 | Combination of 2-19 | Compound 5 | Compound 3 | |
| 3-162 | Combination of 2-38 | Fludioxonil | Compound 3 | |
| 3-163 | Combination of 2-38 | Compound 5 | Compound 3 | |
| 3-164 | Combination of 2-19 | Tolclophos-methyl | Compound 4 | |
| 3-165 | Combination of 2-38 | Metconazole | Compound 4 | |
| 3-166 | Combination of 2-38 | Compound 4 | Compound 5 | |
| 3-167 | Combination of 2-38 | Compound 4 | Compound 1 | |
| 3-168 | Combination of 2-19 | Ipconazole | Compound 4 | |
| 3-169 | Combination of 2-19 | Compound 4 | Compound 5 | |
| 3-170 | Combination of 2-19 | Boscalid | Pyraclostrobin | Metconazole |
| 3-171 | Combination of 2-19 | Boscalid | Pyraclostrobin | Ipconazole |
| 3-172 | Combination of 2-38 | Boscalid | Pyraclostrobin | Metconazole |
| 3-173 | Combination of 2-19 | Boscalid | Pyraclostrobin | Compound 1 |
| 3-174 | Combination of 2-38 | Boscalid | Pyraclostrobin | Compound 1 |
| 3-175 | Combination of 2-19 | Boscalid | Pyraclostrobin | Tolclophos-methyl |
| 3-176 | Combination of 2-38 | Boscalid | Pyraclostrobin | Tolclophos-methyl |
| 3-177 | Combination of 2-32 | Compound 1 | Metconazole | Oxadixyl |
| 3-178 | Combination of 2-32 | Compound 1 | Metconazole | Hymexazol |
| 3-179 | Combination of 2-32 | Compound 1 | Metconazole | Fenamidone |
| 3-180 | Combination of 2-32 | Compound 1 | Metconazole | Cymoxanil |
| 3-181 | Combination of 2-32 | Compound 1 | Metconazole | Fluopicolide |
| 3-182 | Combination of 2-13 | Compound 1 | Metconazole | Oxadixyl |
| 3-183 | Combination of 2-13 | Compound 1 | Metconazole | Hymexazol |
| 3-184 | Combination of 2-13 | Compound 1 | Metconazole | Fenamidone |
| 3-185 | Combination of 2-13 | Compound 1 | Metconazole | Cymoxanil |
| 3-186 | Combination of 2-13 | Compound 1 | Metconazole | Fluopicolide |
| 3-187 | Combination of 2-5 | Ethaboxam | Tolclophos-methyl | Azoxystrobin |
| 3-188 | Combination of 2-5 | Ethaboxam | Tolclophos-methyl | Fluoxastrobin |
| 3-189 | Combination of 2-5 | Ethaboxam | Tolclophos-methyl | Trifloxystrobin |
| 3-190 | Combination of 2-5 | Ethaboxam | Tolclophos-methyl | Pyraclostrobin |
| 3-191 | Combination of 2-5 | Ethaboxam | Tolclophos-methyl | Orysastrobin |
| 3-192 | Combination of 2-5 | Ethaboxam | Tolclophos-methyl | Carboxin |
| 3-193 | Combination of 2-5 | Ethaboxam | Tolclophos-methyl | Penflufen |
| 3-194 | Combination of 2-5 | Ethaboxam | Tolclophos-methyl | Sedaxane |
| 3-195 | Combination of 2-5 | Ethaboxam | Tolclophos-methyl | Fluxapyroxad |
| 3-196 | Combination of 2-19 | Ipconazole | Compound 2 | Fluopyram |
| 3-197 | Combination of 2-38 | Ipconazole | Compound 2 | Oxycarboxin |
| 3-198 | Combination of 2-19 | Metconazole | Compound 2 | Fludioxonil |
| 3-199 | Combination of 2-38 | Metconazole | Compound 2 | Thiram |
| 3-200 | Combination of 2-19 | Tolclophos-methyl | Compound 2 | Captan |
| 3-201 | Combination of 2-38 | Tolclophos-methyl | Compound 2 | Thiophanate-methyl |
| 3-202 | Combination of 2-19 | Compound 1 | Compound 2 | Thiabendazole |
| 3-203 | Combination of 2-72 | Metconazole | | |
| 3-204 | Combination of 2-71 | Metconazole | | |
| 3-205 | Combination of 2-73 | Diphenoconazole | | |
| 3-206 | Combination of 2-73 | Triticonazole | | |
| 3-207 | Combination of 2-73 | Tebuconazole | | |
| 3-208 | Combination of 2-73 | Thiabendazole | | |
| 3-209 | Combination of 2-73 | Carboxin | | |
| 3-210 | Combination of 2-73 | Thiram | | |
| 3-211 | Combination of 2-73 | Captan | | |
| 3-212 | Combination of 2-71 | Compound 1 | | |
| 3-213 | Combination of 2-72 | Compound 1 | | |
| 3-214 | Combination of 2-73 | Compound 1 | | |
| 3-215 | Combination of 2-71 | Tolclophos-methyl | | |
| 3-216 | Combination of 2-72 | Tolclophos-methyl | | |
| 3-217 | Combination of 2-71 | Captan | | |
| 3-218 | Combination of 2-72 | Captan | | |
| 3-219 | Combination of 2-71 | Ethaboxam | Metconazole | |
| 3-220 | Combination of 2-71 | Ethaboxam | Compound 1 | |
| 3-221 | Combination of 2-71 | Ethaboxam | Tolclophos-methyl | |
| 3-222 | Combination of 2-73 | Tolclophos-methyl | | |
| 3-223 | Combination of 2-71 | Ethaboxam | Ipconazole | |
| 3-224 | Combination of 2-71 | Ethaboxam | Diphenoconazole | |
| 3-225 | Combination of 2-71 | Ethaboxam | Triticonazole | |
| 3-226 | Combination of 2-71 | Ethaboxam | Tebuconazole | |
| 3-227 | Combination of 2-71 | Ethaboxam | Thiabendazole | |
| 3-228 | Combination of 2-71 | Ethaboxam | Carboxin | |
| 3-229 | Combination of 2-71 | Ethaboxam | Thiram | |
| 3-230 | Combination of 2-71 | Ethaboxam | Captan | |
| 3-231 | Combination of 2-73 | Ipconazole | | |
| 3-232 | Combination of 2-71 | Fludioxonil | Azoxystrobin | Prothioconazole |
| 3-233 | Combination of 2-71 | Fludioxonil | Pyraclostrobin | Prothioconazole |
| 3-234 | Combination of 2-71 | Fludioxonil | Trifloxystrobin | Prothioconazole |
| 3-235 | Combination of 2-71 | Fludioxonil | Fluoxastrobin | Prothioconazole |
| 3-236 | Combination of 2-71 | Fludioxonil | Azoxystrobin | Triticonazole |
| 3-237 | Combination of 2-71 | Fludioxonil | Pyraclostrobin | Triticonazole |
| 3-238 | Combination of 2-71 | Fludioxonil | Trifloxystrobin | Triticonazole |
| 3-239 | Combination of 2-71 | Fludioxonil | Fluoxastrobin | Triticonazole |
| 3-240 | Combination of 2-71 | Fludioxonil | Azoxystrobin | Tebuconazole |
| 3-241 | Combination of 2-71 | Fludioxonil | Pyraclostrobin | Tebuconazole |
| 3-242 | Combination of 2-71 | Fludioxonil | Trifloxystrobin | Tebuconazole |
| 3-243 | Combination of 2-71 | Fludioxonil | Fluoxastrobin | Tebuconazole |
| 3-244 | Combination of 2-71 | Fludioxonil | Azoxystrobin | Diphenoconazole |
| 3-245 | Combination of 2-71 | Fludioxonil | Pyraclostrobin | Diphenoconazole |
| 3-246 | Combination of 2-71 | Fludioxonil | Trifloxystrobin | Diphenoconazole |
| 3-247 | Combination of 2-71 | Fludioxonil | Fluoxastrobin | Diphenoconazole |
| 3-248 | Combination of 2-72 | Fludioxonil | Azoxystrobin | Prothioconazole |
| 3-249 | Combination of 2-72 | Fludioxonil | Pyraclostrobin | Prothioconazole |
| 3-250 | Combination of 2-72 | Fludioxonil | Trifloxystrobin | Prothioconazole |
| 3-251 | Combination of 2-72 | Fludioxonil | Fluoxastrobin | Prothioconazole |
| 3-252 | Combination of 2-72 | Fludioxonil | Azoxystrobin | Triticonazole |
| 3-253 | Combination of 2-72 | Fludioxonil | Pyraclostrobin | Triticonazole |
| 3-254 | Combination of 2-72 | Fludioxonil | Trifloxystrobin | Triticonazole |
| 3-255 | Combination of 2-72 | Fludioxonil | Fluoxastrobin | Triticonazole |
| 3-256 | Combination of 2-72 | Fludioxonil | Azoxystrobin | Tebuconazole |
| 3-257 | Combination of 2-72 | Fludioxonil | Pyraclostrobin | Tebuconazole |
| 3-258 | Combination of 2-72 | Fludioxonil | Trifloxystrobin | Tebuconazole |
| 3-259 | Combination of 2-72 | Fludioxonil | Fluoxastrobin | Tebuconazole |
| 3-260 | Combination of 2-72 | Fludioxonil | Azoxystrobin | Diphenoconazole |
| 3-261 | Combination of 2-72 | Fludioxonil | Pyraclostrobin | Diphenoconazole |
| 3-262 | Combination of 2-72 | Fludioxonil | Trifloxystrobin | Diphenoconazole |
| 3-263 | Combination of 2-72 | Fludioxonil | Fluoxastrobin | Diphenoconazole |
| 3-264 | Combination of 2-71 | Compound 1 | Compound 2 | |
| 3-265 | Combination of 2-71 | Pyraclostrobin | Compound 2 | |
| 3-266 | Combination of 2-71 | Azoxystrobin | Compound 2 | |
| 3-267 | Combination of 2-71 | Trifloxystrobin | Compound 2 | |
| 3-268 | Combination of 2-71 | Metconazole | Compound 2 | |
| 3-269 | Combination of 2-71 | Prothioconazole | Compound 2 | |
| 3-270 | Combination of 2-71 | Triticonazole | Compound 2 | |
| 3-271 | Combination of 2-71 | Tebuconazole | Compound 2 | |
| 3-272 | Combination of 2-71 | Diphenoconazole | Compound 2 | |
| 3-273 | Combination of 2-71 | Ipconazole | Compound 2 | |
| 3-274 | Combination of 2-71 | Thiophanate-methyl | Compound 2 | |
| 3-275 | Combination of 2-71 | Fludioxonil | Compound 2 | |
| 3-276 | Combination of 2-71 | Tolclophos-methyl | Compound 2 | |
| 3-277 | Combination of 2-71 | Thiuram | Compound 2 | |
| 3-278 | Combination of 2-71 | Captan | Compound 2 | |
| 3-279 | Combination of 2-71 | Carboxin | Compound 2 | |
| 3-280 | Combination of 2-71 | Penflufen | Compound 2 | |
| 3-281 | Combination of 2-71 | Sedaxane | Compound 2 | |
| 3-282 | Combination of 2-71 | Fluxapyroxad | Compound 2 | |
| 3-283 | Combination of 2-71 | Fluopyram | Compound 2 | |
| 3-284 | Combination of 2-71 | Boscalid | Compound 2 | |
| 3-285 | Combination of 2-71 | Thiabendazole | Compound 2 | |
| 3-286 | Combination of 2-72 | Compound 1 | Compound 2 | |
| 3-287 | Combination of 2-72 | Pyraclostrobin | Compound 2 | |
| 3-288 | Combination of 2-72 | Azoxystrobin | Compound 2 | |
| 3-289 | Combination of 2-72 | Trifloxystrobin | Compound 2 | |
| 3-290 | Combination of 2-72 | Metconazole | Compound 2 | |
| 3-291 | Combination of 2-72 | Prothioconazole | Compound 2 | |
| 3-292 | Combination of 2-72 | Triticonazole | Compound 2 | |
| 3-293 | Combination of 2-72 | Tebuconazole | Compound 2 | |
| 3-294 | Combination of 2-72 | Diphenoconazole | Compound 2 | |
| 3-295 | Combination of 2-72 | Ipconazole | Compound 2 | |
| 3-296 | Combination of 2-72 | Thiophanate-methyl | Compound 2 | |
| 3-297 | Combination of 2-72 | Fludioxonil | Compound 2 | |
| 3-298 | Combination of 2-72 | Tolclophos-methyl | Compound 2 | |
| 3-299 | Combination of 2-72 | Thiuram | Compound 2 | |
| 3-300 | Combination of 2-72 | Captan | Compound 2 | |
| 3-301 | Combination of 2-72 | Carboxin | Compound 2 | |
| 3-302 | Combination of 2-72 | Penflufen | Compound 2 | |
| 3-303 | Combination of 2-72 | Sedaxane | Compound 2 | |
| 3-304 | Combination of 2-72 | Fluxapyroxad | Compound 2 | |
| 3-305 | Combination of 2-72 | Fluopyram | Compound 2 | |
| 3-306 | Combination of 2-72 | Boscalid | Compound 2 | |
| 3-307 | Combination of 2-72 | Thiabendazole | Compound 2 | |
| 3-308 | Combination of 2-71 | Compound 1 | Compound 3 | |
| 3-309 | Combination of 2-71 | Pyraclostrobin | Compound 3 | |
| 3-310 | Combination of 2-71 | Azoxystrobin | Compound 3 | |
| 3-311 | Combination of 2-71 | Trifloxystrobin | Compound 3 | |
| 3-312 | Combination of 2-71 | Metconazole | Compound 3 | |
| 3-313 | Combination of 2-71 | Prothioconazole | Compound 3 | |
| 3-314 | Combination of 2-71 | Triticonazole | Compound 3 | |
| 3-315 | Combination of 2-71 | Tebuconazole | Compound 3 | |
| 3-316 | Combination of 2-71 | Diphenoconazole | Compound 3 | |
| 3-317 | Combination of 2-71 | Ipconazole | Compound 3 | |
| 3-318 | Combination of 2-71 | Thiophanate-methyl | Compound 3 | |
| 3-319 | Combination of 2-71 | Fludioxonil | Compound 3 | |
| 3-320 | Combination of 2-71 | Tolclophos-methyl | Compound 3 | |
| 3-321 | Combination of 2-71 | Thiuram | Compound 3 | |
| 3-322 | Combination of 2-71 | Captan | Compound 3 | |
| 3-323 | Combination of 2-71 | Carboxin | Compound 3 | |
| 3-324 | Combination of 2-71 | Penflufen | Compound 3 | |
| 3-325 | Combination of 2-71 | Sedaxane | Compound 3 | |
| 3-326 | Combination of 2-71 | Fluxapyroxad | Compound 3 | |
| 3-327 | Combination of 2-71 | Fluopyram | Compound 3 | |
| 3-328 | Combination of 2-71 | Boscalid | Compound 3 | |
| 3-329 | Combination of 2-71 | Thiabendazole | Compound 3 | |
| 3-330 | Combination of 2-72 | Compound 1 | Compound 3 | |
| 3-331 | Combination of 2-72 | Pyraclostrobin | Compound 3 | |
| 3-332 | Combination of 2-72 | Azoxystrobin | Compound 3 | |
| 3-333 | Combination of 2-72 | Trifloxystrobin | Compound 3 | |
| 3-334 | Combination of 2-72 | Metconazole | Compound 3 | |
| 3-335 | Combination of 2-72 | Prothioconazole | Compound 3 | |
| 3-336 | Combination of 2-72 | Triticonazole | Compound 3 | |
| 3-337 | Combination of 2-72 | Tebuconazole | Compound 3 | |
| 3-338 | Combination of 2-72 | Diphenoconazole | Compound 3 | |
| 3-339 | Combination of 2-72 | Ipconazole | Compound 3 | |
| 3-340 | Combination of 2-72 | Thiophanate-methyl | Compound 3 | |
| 3-341 | Combination of 2-72 | Fludioxonil | Compound 3 | |
| 3-342 | Combination of 2-72 | Tolclophos-methyl | Compound 3 | |
| 3-343 | Combination of 2-72 | Thiuram | Compound 3 | |
| 3-344 | Combination of 2-72 | Captan | Compound 3 | |
| 3-345 | Combination of 2-72 | Carboxin | Compound 3 | |
| 3-346 | Combination of 2-72 | Penflufen | Compound 3 | |
| 3-347 | Combination of 2-72 | Sedaxane | Compound 3 | |
| 3-348 | Combination of 2-72 | Fluxapyroxad | Compound 3 | |
| 3-349 | Combination of 2-72 | Fluopyram | Compound 3 | |
| 3-350 | Combination of 2-72 | Boscalid | Compound 3 | |
| 3-351 | Combination of 2-72 | Thiabendazole | Compound 3 | |
| 3-352 | Combination of 2-71 | Compound 1 | Compound 4 | |
| 3-353 | Combination of 2-71 | Pyraclostrobin | Compound 4 | |
| 3-354 | Combination of 2-71 | Azoxystrobin | Compound 4 | |
| 3-355 | Combination of 2-71 | Trifloxystrobin | Compound 4 | |
| 3-356 | Combination of 2-71 | Metconazole | Compound 4 | |
| 3-357 | Combination of 2-71 | Prothioconazole | Compound 4 | |
| 3-358 | Combination of 2-71 | Triticonazole | Compound 4 | |
| 3-359 | Combination of 2-71 | Tebuconazole | Compound 4 | |
| 3-360 | Combination of 2-71 | Diphenoconazole | Compound 4 | |
| 3-361 | Combination of 2-71 | Ipconazole | Compound 4 | |
| 3-362 | Combination of 2-71 | Thiophanate-methyl | Compound 4 | |
| 3-363 | Combination of 2-71 | Fludioxonil | Compound 4 | |
| 3-364 | Combination of 2-71 | Tolclophos-methyl | Compound 4 | |
| 3-365 | Combination of 2-71 | Thiuram | Compound 4 | |
| 3-366 | Combination of 2-71 | Captan | Compound 4 | |
| 3-367 | Combination of 2-71 | Carboxin | Compound 4 | |
| 3-368 | Combination of 2-71 | Penflufen | Compound 4 | |
| 3-369 | Combination of 2-71 | Sedaxane | Compound 4 | |
| 3-370 | Combination of 2-71 | Fluxapyroxad | Compound 4 | |
| 3-371 | Combination of 2-71 | Fluopyram | Compound 4 | |
| 3-372 | Combination of 2-71 | Boscalid | Compound 4 | |
| 3-373 | Combination of 2-71 | Thiabendazole | Compound 4 | |
| 3-374 | Combination of 2-72 | Compound 1 | Compound 4 | |
| 3-375 | Combination of 2-72 | Pyraclostrobin | Compound 4 | |
| 3-376 | Combination of 2-72 | Azoxystrobin | Compound 4 | |
| 3-377 | Combination of 2-72 | Trifloxystrobin | Compound 4 | |
| 3-378 | Combination of 2-72 | Metconazole | Compound 4 | |
| 3-379 | Combination of 2-72 | Prothioconazole | Compound 4 | |
| 3-380 | Combination of 2-72 | Triticonazole | Compound 4 | |
| 3-381 | Combination of 2-72 | Tebuconazole | Compound 4 | |
| 3-382 | Combination of 2-72 | Diphenoconazole | Compound 4 | |
| 3-383 | Combination of 2-72 | Ipconazole | Compound 4 | |
| 3-384 | Combination of 2-72 | Thiophanate-methyl | Compound 4 | |
| 3-385 | Combination of 2-72 | Fludioxonil | Compound 4 | |
| 3-386 | Combination of 2-72 | Tolclophos-methyl | Compound 4 | |
| 3-387 | Combination of 2-72 | Thiuram | Compound 4 | |
| 3-388 | Combination of 2-72 | Captan | Compound 4 | |
| 3-389 | Combination of 2-72 | Carboxin | Compound 4 | |
| 3-390 | Combination of 2-72 | Penflufen | Compound 4 | |
| 3-391 | Combination of 2-72 | Sedaxane | Compound 4 | |
| 3-392 | Combination of 2-72 | Fluxapyroxad | Compound 4 | |
| 3-393 | Combination of 2-72 | Fluopyram | Compound 4 | |
| 3-394 | Combination of 2-72 | Boscalid | Compound 4 | |
| 3-395 | Combination of 2-72 | Thiabendazole | Compound 4 | |
| 3-396 | Combination of 2-74 | Azoxystrobin | Abamectin | Sedaxane |
| 3-397 | Combination of 2-75 | Azoxystrobin | Abamectin | Sedaxane |
| 3-398 | Combination of 2-76 | Fluxapyroxad | | |
| 3-399 | Combination of 2-77 | Fluxapyroxad | | |
| 3-400 | Combination of 2-81 | Fluxapyroxad | | |
| 3-401 | Combination of 2-78 | Penflufen | | |
| 3-402 | Combination of 2-79 | Penflufen | | |
| 3-403 | Fipronil | Pyraclostrobin | Thiophanate-methyl | Fluxapyroxad |
| 3-404 | Fluoxastrobin | Prothioconazole | Tebuconazole | Triazoxide |
| 3-405 | Combination of 3-398 | Sedaxane | | |
| 3-406 | Combination of 3-399 | Sedaxane | | |
| 3-407 | Combination of 2-85 | Trifloxystrobin | Fluxapyroxad | Thiodicarb |
| 3-408 | Combination of 2-86 | Trifloxystrobin | Fluxapyroxad | Thiodicarb |
| 3-409 | Combination of 2-85 | Pyraclostrobin | Fluxapyroxad | Thiodicarb |
| 3-410 | Combination of 2-86 | Pyraclostrobin | Fluxapyroxad | Thiodicarb |

According to the method of controlling pests of the present invention, pests in clop fields can be efficiently controlled.

1. A method of controlling weeds in a crop field, the method including treating the crop field with crystal of flumioxazin, before sowing or planting, at the same time of sowing or planting, or after sowing or planting crop seeds or vegetative organs such as tubers, bulbs, or stem fragments which are treated with one or more compounds selected from the following group B;
Group B: neonicotinoid type compounds, diamide type compounds, carbamate type compounds, organic phosphorous type compounds, biological nematicidal compounds, other insecticidal compounds and nematicidal compounds, azole type compounds, strobilurin type compounds, metalaxyl type compounds, SDHI compounds, and other fungicidal compounds and plant growth regulators,
wherein the crystal of flumioxazin is one or more selected from the group consisting of 1^{st} crystal, 2^{nd} crystal, 3^{rd} crystal, 4^{th} crystal, 5^{th} crystal, 6^{th} crystal and 7^{th} crystal,
each of the crystals showing a powder X-Ray diffraction pattern which has diffraction peaks with 2θ values (°) shown in the corresponding right column of Table 1,
TABLE 1

| | 2θ value (°) |
|---|---|
| 1^{st} crystal | 7.5 ± 0.1, 11.9 ± 0.1, 15.3 ± 0.1 |
| 2^{nd} crystal | 8.7 ± 0.1, 9.4 ± 0.1, 14.7 ± 0.1, |
| | 18.8 ± 0.1 |
| 3^{rd} crystal | 7.7 ± 0.1, 10.9 ± 0.1, 13.5 ± 0.1, |
| | 14.6 ± 0.1, 15.0 ± 0.1 |
| 4^{th} crystal | 7.7 ± 0.1, 10.7 ± 0.1, 13.4 ± 0.1, |
| | 14.3 ± 0.1, 14.8 ± 0.1 |
| 5^{th} crystal | 5.5 ± 0.1, 10.3 ± 0.1, 10.9 ± 0.1, |
| | 13.2 ± 0.1 |
| 6^{th} crystal | 7.7 ± 0.1, 8.6 ± 0.1, 11.0 ± 0.1, |
| | 13.2 ± 0.1, 14.7 ± 0.1, 15.1 ± 0.1, |
| 7^{th} crystal | 14.5 ± 0.1, 18.7 ± 0.1 |

2. A method of controlling pests in a crop field, the method including the steps of:
treating crop seeds or vegetative organs such as tubers, bulbs, or stem fragments with one or more compounds selected from the group B;
Group B: neonicotinoid type compounds, diamide type compounds, carbamate type compounds, organic phosphorous type compounds, biological nematicidal compounds, other insecticidal compounds and nematicidal compounds, azole type compounds, strobilurin type compounds, metalaxyl type compounds, SDHI compounds, and other fungicidal compounds and plant growth regulators; and
treating the crop field with crystal of flumioxazin,
before sowing or planting, at the same time of sowing or planting, or after sowing or planting the crop seeds or vegetative organs such as tubers, bulbs, or stem fragments which are treated with the compounds of the group B,
wherein the crystal of flumioxazin
is one or more selected from the group consisting of 1^{st} crystal, 2^{nd} crystal, 3^{rd} crystal, 4^{th} crystal, 5^{th} crystal, 6^{th} crystal and 7^{th} crystal,
each of the crystals showing a powder X-Ray diffraction pattern which has diffraction peaks with 2θ values (°) shown in the corresponding right column of Table 1,
TABLE 1

| | 2θ value (°) |
|---|---|
| 1^{st} crystal | 7.5 ± 0.1, 11.9 ± 0.1, 15.3 ± 0.1 |
| 2^{nd} crystal | 8.7 ± 0.1, 9.4 ± 0.1, 14.7 ± 0.1, |
| | 18.8 ± 0.1 |
| 3^{rd} crystal | 7.7 ± 0.1, 10.9 ± 0.1, 13.5 ± 0.1, |
| | 14.6 ± 0.1, 15.0 ± 0.1 |
| 4^{th} crystal | 7.7 ± 0.1, 10.7 ± 0.1, 13.4 ± 0.1, |
| | 14.3 ± 0.1, 14.8 ± 0.1 |
| 5^{th} crystal | 5.5 ± 0.1, 10.3 ± 0.1, 10.9 ± 0.1, |
| | 13.2 ± 0.1 |
| 6^{th} crystal | 7.7 ± 0.1, 8.6 ± 0.1, 11.0 ± 0.1, |
| | 13.2 ± 0.1, 14.7 ± 0.1, 15.1 ± 0.1, |
| 7^{th} crystal | 14.5 ± 0.1, 18.7 ± 0.1 |

3. The control method according to claim 1, wherein the group B is the following compounds:
group B:
B-1, neonicotinoid type compounds: clothianidin, thiamethoxam, imidacloprid, dinotefuran, nitenpyram, acetamiprid, and thiacloprid;
diamide type compounds: flubendiamide, chlorantraniliprole, cyantraniliprole, and compounds represented by the formula (I): 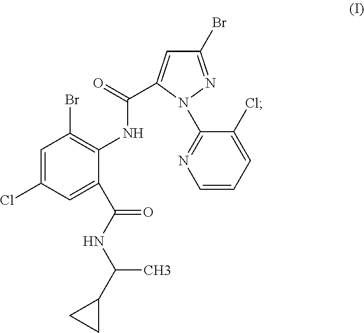 [SMILES: CC(NC(=O)c1cc(Cl)cc(Br)c1NC(=O)c1cc(Br)nn1-c1ncccc1Cl)C1CC1]
B-2. carbamate type compounds: aldicarb, oxamyl, thiodicarb, carbofuran, carbosulfan, and dimethoate;
B-3, organic phosphorous type compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
B-4, biological nematicidal compounds: Harpin Protein, Pasteuria nishizawae, Pasteuria penetrans, Myrothecium verrucaria, Burholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;
B-5, other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
B-6, azole type compounds: azaconazole, bitertanol, bromuconazole, cyproconazole, diphenoconazole, diniconazole, epoxyconazole, fenbuconazole, fluquinconazole, flusilazole, flutriafol, hexaconazole, imibenconazole, ipconazole, metconazole, mycrobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizol;
B-7, strobilurin type compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxy)methyl]phenyl-2-methoxy-acetamide (racemic or enantiomer, containing a mixture of R-enantiomer and S-enantiomer (optional ratio));
B-8, metalaxyl type compounds: metalaxyl and metalaxyl-M;
B-9, SDHI compounds: sedaxane, penflufen, carboxin, boscalid, furametpyr, flutolanil, fluxapyroxad, isopyrazam, fluopyram, and thifluzamide;
B-10, other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
B-11, plant growth inhibitors: ethephon, chlormequat-chloride, mepiquat-chloride, and 4-oxo-4-(2-phenylethyl)aminobutyric acid.

4. The control method according to claim 1, wherein the crop is soybean, peanut, common bean, pea, corn, cotton, wheat, rice, sunflower, potato, sugar cane, or vegetables.

5. The control method according to claim 2, wherein the pests are weeds and/or arthropods and/or plant pathogens.

6. The control method according to claim 2, wherein the pests are weeds.

7. The control method according to claim 2, wherein the group B is the following compounds:
group B:
B-1, neonicotinoid type compounds: clothianidin, thiamethoxam, imidacloprid, dinotefuran, nitenpyram, acetamiprid, and thiacloprid;
diamide type compounds: flubendiamide, chlorantraniliprole, cyantraniliprole, and compounds represented by the formula (I): 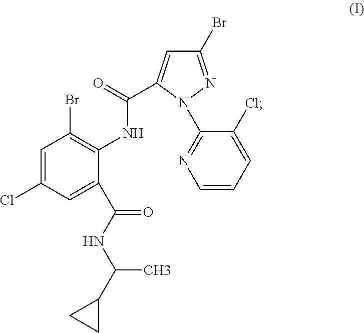 [SMILES: CC(NC(=O)c1cc(Cl)cc(Br)c1NC(=O)c1cc(Br)nn1-c1ncccc1Cl)C1CC1]
B-2, carbamate type compounds: aldicarb, oxamyl, thiodicarb, carbofuran, carbosulfan, and dimethoate;
B-3, organic phosphorous type compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
B-4, biological nematicidal compounds: Harpin Protein, Pasteuria nishizawae, Pasteuria penetrans, Myrothecium verrucaria, Burholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;
B-5, other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
B-6, azole type compounds: azaconazole, bitertanol, bromuconazole, cyproconazole, diphenoconazole, diniconazole, epoxyconazole, fenbuconazole, fluquinconazole, flusilazole, flutriafol, hexaconazole, imibenconazole, ipconazole, metconazole, mycrobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizol;
B-7, strobilurin type compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxy)methyl]phenyl-2-methoxy-acetamide (racemic or enantiomer, containing a mixture of R-enantiomer and S-enantiomer (optional ratio));
B-8, metalaxyl type compounds: metalaxyl and metalaxyl-M;
B-9, SDHI compounds: sedaxane, penflufen, carboxin, boscalid, furametpyr, flutolanil, fluxapyroxad, isopyrazam, fluopyram, and thifluzamide;
B-10, other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
B-11, plant growth inhibitors: ethephon, chlormequat-chloride, mepiquat-chloride, and 4-oxo-4-(2-phenylethyl)aminobutyric acid.

8. The control method according to claim 2, wherein the crop is soybean, peanut, common bean, pea, corn, cotton, wheat, rice, sunflower, potato, sugar cane, or vegetables.

9. The control method according to claim 3, wherein the crop is soybean, peanut, common bean, pea, corn, cotton, wheat, rice, sunflower, potato, sugar cane, or vegetables.

10. The control method according to claim 7, wherein the crop is soybean, peanut, common bean, pea, corn, cotton, wheat, rice, sunflower, potato, sugar cane, or vegetables.

11. The control method according to claim 3, wherein the pests are weeds and/or arthropods and/or plant pathogens.

12. The control method according to claim 4, wherein the pests are weeds and/or arthropods and/or plant pathogens.

13. The control method according to claim 7, wherein the pests are weeds and/or arthropods and/or plant pathogens.

14. The control method according to claim 8, wherein the pests are weeds and/or arthropods and/or plant pathogens.

15. The control method according to claim 9, wherein the pests are weeds and/or arthropods and/or plant pathogens.

16. The control method according to claim 10, wherein the pests are weeds and/or arthropods and/or plant pathogens.

17. The control method according to claim 3, wherein the pests are weeds.

18. The control method according to claim 4, wherein the pests are weeds.

19. The control method according to claim 7, wherein the pests are weeds.

20. The control method according to claim 8, wherein the pests are weeds.
